(19) United States
(12) Patent Application Publication
(10) Pub. No.: US 2026/0346301 A1
(43) Pub. Date: Nov. 5, 2026

(54) Piezoelectric Element, Ultrasonic Transducer and Method for Manufacturing the Same

(71) Applicant: Suncall Corporation, Kyoto-shi, Kyoto (JP)

(72) Inventors: Yuuya UNO, Kyoto-shi, Kyoto (JP); Satoru TAKASUGI, Kyoto-shi, Kyoto (JP)

(21) Appl. No.: 19/104,981

(22) PCT Filed: Mar. 27, 2023
(86) PCT No.: PCT/JP2023/012118

§ 371 Date: Feb. 19, 2025

(51) Int. Cl. B06B 1/06

(52) U.S. Cl. CPC B06B 1/0629

(57) ABSTRACT

A piezoelectric element of this invention includes upper and lower electrodes forming an external electrode, an internal electrode, a lower electrode connector including a lower electrode terminal adjacent to the upper electrode via a lower-electrode-side gap, an internal electrode connector including an internal electrode terminal adjacent to the upper electrode via an internal-electrode-side gap, and an insulating cover member integrally covering at least a part of the internal electrode terminal, an internal-electrode-terminal facing area of the upper electrode facing the internal electrode terminal via the internal-electrode-side gap, and an area of the internal-electrode-side gap sandwiched by the internal electrode terminal and the internal-electrode-terminal facing area, wherein the insulating cover member is provided with an internal electrode opening that exposes at least a part of the internal electrode terminal without exposing the internal-electrode-terminal facing area.

### FIELD OF THE INVENTION

The present invention relates to a piezoelectric element, an ultrasonic transducer having a piezoelectric element and a wiring structure with first and second wirings that are electrically connected to external and internal electrodes of the piezoelectric element, respectively, and a manufacturing method of the ultrasonic transducer.

### BACKGROUND ART

As a laminated piezoelectric element, there has been proposed a piezoelectric element including: a piezoelectric element main body made of a piezoelectric material; an upper electrode and a lower electrode provided on an upper surface and a lower surface of the piezoelectric element main body, respectively; an internal electrode for dividing the piezoelectric element main body into a first piezoelectric portion on an upper side and a second piezoelectric portion on a lower side in a thickness direction; a lower electrode connector having a base end that is electrically connected to the lower electrode and a tip end that forms a lower electrode terminal provided on the upper surface of the piezoelectric element main body in such a manner that there is a lower-electrode-side gap between the lower electrode terminal and the upper electrode; and an internal electrode connector having a base end that is electrically connected to the internal electrode and a tip end that forms an internal electrode terminal provided on the upper surface of the piezoelectric element main body in such a manner that there is an internal-electrode-side gap between the internal electrode terminal and the upper electrode (see Patent Literature 1).

The laminated piezoelectric element having a configuration as described above is useful in that electrical connection of associated wiring with respect to all the electrodes including both of the upper electrode and the lower electrode forming an external electrode, and the internal electrodes can be performed at the upper surface on one side in the thickness direction.

That is, a first conductive adhesive is provided in such a way as to extend across both of the lower electrode terminal and a lower-electrode-terminal facing area out of the upper electrode facing the lower electrode terminal via or through the lower-electrode-side gap, and a corresponding first wiring is connected to the first conductive adhesive, whereby electrical connection of the first wiring to both of the upper electrode and the lower electrode can be performed on the upper surface of the piezoelectric element. Further, a second conductive adhesive is provided on the internal electrode terminal, and a corresponding second wiring is connected to the second conductive adhesive, whereby electrical connection of the second wiring to the internal electrode can be performed on the upper surface of the piezoelectric element .

The piezoelectric element converts a voltage applied between the external electrode and the internal electrode into a flexural vibration, or converts a vibration to be propagated into a voltage between the first and second electrodes, and in order to improve conversion efficiency between the voltage and the flexural vibration, it is necessary to increase a facing area between the upper electrode and the internal electrode, and a facing area between the internal electrode and the lower electrode as much as possible.

However, in order to increase the facing area between the upper electrode and the internal electrode as much as possible, it is necessary to increase an area of the upper electrode itself as much as possible, which causes the following problem.

That is, an increase in the area of the upper electrode leads to narrowing of the internal-electrode-side gap, and the risk of contact of the second conductive adhesive with the upper electrode increases due to a variation in the application amount and a variation in the application position of the second conductive adhesive to be applied onto the internal electrode terminal. This leads to lowering in the yield due to short-circuiting between the external electrode (the upper electrode) and the internal electrode, or lowering in the efficiency of an application operation of the second conductive adhesive.

Further, even when the second conductive adhesive does not come into contact with the upper electrode during an application operation of the second conductive adhesive, narrowing of the internal-electrode-side gap may cause ion migration under the use environmental conditions of the piezoelectric element such as high temperature and high humidity, which may lead to a short circuit failure.

### PRIOR ART DOCUMENT

### Patent Literature

Patent Literature 1: Japanese Patent No. 6776481

### SUMAARY OF THE INVENTION

The present invention has been made in consideration of the conventional technology, and it is a first object to provide a laminated piezoelectric element allowing, at an upper surface on one side in a thickness direction, an external electrode including an upper electrode and a lower electrode and an internal electrode to be electrically connected to corresponding wirings, respectively, the laminated piezoelectric element capable of improving conversion efficiency between a voltage applied to the piezoelectric element and a flexural vibration of the piezoelectric element while effectively preventing short-circuiting between the external electrode and the internal electrode.

Moreover, it is a second object of the present invention to provide an ultrasonic transducer including a laminated piezoelectric element capable of improving conversion efficiency between a voltage applied to the piezoelectric element and a flexural vibration of the piezoelectric element while effectively preventing short-circuiting between external and internal electrodes of the piezoelectric element.

Furthermore, it is a third object of the present invention to provide a manufacturing method of capable of efficiently manufacturing the ultrasonic transducer.

In order to achieve the first object, a first aspect of the present invention provides a laminated piezoelectric element including a piezoelectric element main body made of a piezoelectric material; upper and lower electrodes provided on upper and lower surfaces of the piezoelectric element main body, respectively, the upper and lower electrodes forming an external electrode; an internal electrode dividing the piezoelectric element main body into upper and lower sides in a thickness direction; a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode; an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode; an insulating cover member integrally covering at least a part of the internal electrode terminal, an internal-electrode-terminal facing area of the upper electrode that faces the internal electrode terminal via or through the internal-electrode-side gap, and an area of the internal-electrode-side gap that is sandwiched by the internal electrode terminal and the internal-electrode-terminal facing area; and an internal electrode opening provided at the insulating cover member so as to expose at least a part of the internal electrode terminal without exposing the internal-electrode-terminal facing area.

The laminated piezoelectric element according to the first aspect makes it possible to, at an upper surface on one side in a thickness direction, electrically connect the external electrode including the upper and lower electrodes to a corresponding wiring and also electrically connect the internal electrode to a corresponding wiring, and also improve the conversion efficiency between a voltage applied to the piezoelectric element and the flexural vibration of the piezoelectric element while effectively preventing short-circuiting between the external and internal electrodes.

In the first aspect, the internal electrode opening may be configured to expose an area of the internal-electrode-side gap that is adjacent to the exposed part of the internal electrode terminal.

Alternatively, the internal electrode opening may be configured not to expose the internal-electrode-side gap.

In a first configuration of the first aspect, the insulating cover member is configured to integrally cover at least a part of the lower electrode terminal, a lower-electrode-terminal facing area of the upper electrode facing the lower electrode terminal via or through the lower-electrode-side gap, and an area of the lower-electrode-side gap that is sandwiched by the lower electrode terminal and the lower-electrode-terminal facing area.

In this case, the insulating cover member is provided with, in addition to the internal electrode opening, an external electrode opening that integrally exposes at least a part of the lower electrode terminal and at least a part of the upper electrode.

In the first configuration of the first aspect, the insulating cover member may be, for example, configured to cover a whole of the upper surface of the piezoelectric element main body in a plan view.

Alternatively, the insulating cover member may be configured to cover a part of the upper surface of the piezoelectric element main body in a plan view.

In order to achieve the second object, a second aspect of the present invention provides an ultrasonic transducer including a rigid substrate provided with a plurality of opening portions penetrating between an upper surface and a lower surface; a flexible resin film fixed to the upper surface of the substrate in such a way as to cover the plurality of opening portions; a lower sealing plate having a central opening of a size that integrally surrounds the plurality of opening portions, and fixed to the upper surface of the flexible resin film in such a way that the central opening integrally surrounds the plurality of opening portions in a plan view; a plurality of piezoelectric elements arranged onto the upper surface of the flexible resin film within the central opening so as to overlap, in a plan view, the plurality of opening portions, respectively; an insulating resin material fixing the plurality of piezoelectric elements at respective arrangement positions; and a wiring structure including first and second wirings and fixed to an upper surface of the lower sealing plate, wherein the piezoelectric element includes a piezoelectric element main body made of a piezoelectric material, upper and lower electrodes provided on upper and lower surfaces of the piezoelectric element main body, respectively, the upper and lower electrodes forming an external electrode, an internal electrode dividing the piezoelectric element main body into an upper side and a lower side in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode, and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode, wherein the insulating resin material is provided in such a way as to be interposed between lower surfaces of the plurality of piezoelectric elements and the flexible resin film, and also cover side surfaces and upper surfaces of the plurality of piezoelectric elements, wherein a portion of the insulating resin material that covers an upper surface of the piezoelectric element to form an insulating cover member is provided with an external electrode opening that integrally exposes at least a part of the lower electrode terminal and at least a part of the upper electrode, and an internal electrode opening that exposes at least a part of the internal electrode terminal without exposing the internal-electrode-terminal facing area, wherein the first wiring is electrically connected via a first conductive bonding material to the lower electrode terminal and the upper electrode that are exposed by the external electrode opening, and wherein the second wiring is electrically connected via a second conductive bonding material to the internal electrode terminal that is exposed by the internal electrode opening.

In a first configuration of the second aspect, the insulating resin material includes a first insulating resin material that fixes the lower surfaces of plurality of the piezoelectric element to the flexible resin film, and a second insulating resin material that covers the side surfaces and the upper surfaces of the plurality of the piezoelectric element.

Alternatively, in a second configuration of the second aspect, the insulating resin material is made of a single material.

In a preferable configuration of the second aspect, the lower sealing plate includes a partition wall that divides the central opening into a plurality of openings having a size that surrounds the corresponding piezoelectric element.

In the second aspect, the wiring structure may include an insulating base layer supporting the first and second wirings, and an insulating cover layer covering at least parts of the first and second wirings from a side opposite to the base layer. The base layer and the cover layer each may include a plurality of piezoelectric element overlapping portions that partially overlap, in a plan view, the plurality of piezoelectric elements, respectively, and a tip end portion that integrally holds the plurality of piezoelectric element overlapping portions.

The piezoelectric element overlapping portion of a piezoelectric-element-side insulating layer out of the base layer and the cover layer, which is located on a side facing the piezoelectric element, may include an external-electrode tab area that overlaps, in a plan view, an area integrally surrounding at least a part of the lower electrode terminal and at least a part of the lower-electrode-terminal facing area and includes an external-electrode connection opening, and an internal-electrode tab area that overlaps, in a plan view, at least a part of the internal electrode terminal and includes an internal-electrode connection opening.

The first wiring is configured to have a part extending across or straddles the external-electrode connection opening, and the second wiring is configured to have a part extending across or straddles the internal-electrode connection opening. The wiring structure is fixed to the upper surface of the lower sealing plate in a state that the external-electrode connection opening overlaps, in a plan view, the area that integrally includes at least a part of the lower electrode terminal and at least a part of the lower-electrode facing area, and the internal-electrode connection opening overlaps, in a plan view, at least a part of the internal electrode terminal. The part of the first wiring extending across the external-electrode connection opening is bonded to the first conductive bonding material, and the part of the second wiring extending across the internal-electrode connection opening is bonded to the second conductive bonding material.

In a preferable configuration, the piezoelectric element overlapping portion of the insulating layer out of the base layer and the cover layer, which is located on a side away from the piezoelectric element, may include an external-electrode tab area that overlaps, in a plan view, an area integrally surrounding at least a part of the lower electrode terminal and at least a part of the lower-electrode-terminal facing area and includes a first access opening, and an internal-electrode tab area that overlaps, in a plan view, at least a part of the internal electrode terminal and includes a second access opening.

In order to achieve the third object, a third aspect of the present invention provides a manufacturing method of an ultrasonic transducer including a rigid substrate provided with a plurality of opening portions penetrating between an upper surface and a lower surface, a flexible resin film fixed to the upper surface of the substrate in such a way as to cover the plurality of opening portions, the same number of piezoelectric elements as the plurality of opening portions, the piezoelectric element being fixed to the upper surface of the flexible resin film in such a way that a middle portion thereof overlaps, in a plan view, the corresponding opening portion and a peripheral portion thereof overlaps, in a plan view, the upper surface of the rigid substrate, and a wiring structure including first and second wirings that are electrically connected to external and internal electrodes of the piezoelectric element, respectively, wherein the piezoelectric element includes a piezoelectric element main body made of a piezoelectric material, upper and lower electrodes provided on upper and lower surfaces of the piezoelectric element main body, respectively, the upper and lower electrodes forming the external electrode, the internal electrode dividing the piezoelectric element main body into upper and lower sides in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode, the manufacturing method including: a rigid substrate forming step of preparing a rigid plate member having the same thickness as the rigid substrate and forming the plurality of opening portions in the rigid plate member to obtain the rigid substrate; a flexible resin film fixing step of fixing the flexible resin film to the upper surface of the rigid substrate so as to cover the plurality of opening portions; a piezoelectric element fixing step of fixing the plurality of piezoelectric elements to the upper surface of the flexible resin film by an insulating adhesive in such a way as to overlap, in a plan view, the plurality of opening portions, respectively; an insulating cover member setting step of setting an insulating cover member on the upper surface of the piezoelectric element in such a manner as to integrally cover at least a part of the internal electrode terminal, an internal-electrode-terminal facing area of the upper electrode facing the internal electrode terminal via or through the internal-electrode-side gap and an area of the internal-electrode-side gap that is sandwiched by the internal electrode terminal and the internal-electrode-terminal facing area; an electrode exposing step of forming, in the insulating cover member, an internal electrode opening that exposes at least a part of the internal electrode terminal without exposing the internal-electrode-terminal facing area; a conductive bonding material setting step of setting a first conductive bonding material in such a way as to integrally cover at least a part of the lower electrode terminal and at least a part of a lower-electrode-terminal facing area of the upper electrode facing the lower electrode terminal via or through the lower-electrode-side gap, and setting a second conductive bonding material at an area of the internal electrode terminal that is exposed through the internal electrode opening; and a wiring structure setting step of setting the wiring structure in such a manner that a part of the first wiring comes into contact with the first conductive bonding material and a part of the second wiring comes into contact with the second conductive bonding material.

In a preferable configuration of the third aspect, the electrode exposing step may be configured to form the internal electrode opening by emitting laser beam onto a portion of the insulating cover member where the internal electrode opening should be formed.

In a first configuration of the third aspect, the insulating cover member may be configured not to cover at least a part of the lower electrode terminal, the lower-electrode-terminal facing area of the upper electrode facing the lower electrode terminal via or through the lower-electrode-side gap, and an area of the lower-electrode-side gap that is sandwiched by the lower electrode terminal and the lower-electrode-terminal facing area.

In a second configuration of the third aspect, the insulating cover member is configured to integrally cover at least a part of the lower electrode terminal, the lower-electrode-terminal facing area of the upper electrode facing the lower electrode terminal via or through the lower-electrode-side gap, and an area of the lower-electrode-side gap that is sandwiched by the lower electrode terminal and the lower-electrode-terminal facing area.

In this case, the electrode exposing step may be configured to form, in addition to the internal electrode opening, an external electrode opening that integrally exposes at least a part of the lower electrode terminal and at least a part of the upper electrode, and the conductive bonding material setting step may be configured to set the first conductive bonding material within the external electrode opening.

The manufacturing method according to the third aspect may further include a lower sealing plate fixing step of preparing a lower sealing plate that has the substantially same thickness as the piezoelectric element and includes a central opening of a size integrally surrounding the plurality of opening portions in the rigid substrate, and fixing the lower sealing plate to the upper surface of the flexible resin film in such a way that the central opening integrally surrounds the plurality of opening portions in a plan view.

The lower sealing plate fixing step is performed at an arbitrary timing after the flexible resin film fixing step and before the wiring structure setting step, and is configured so as to mount the wiring structure onto the lower sealing plate.

In a preferable configuration, the manufacturing method according to the third aspect may further include an insulating resin material filling step that is performed after the lower sealing plate fixing step and the piezoelectric element fixing step and before the wiring structure setting step, wherein the insulating resin material filling step is configured to fill with an insulating resin material a side space of each of the plurality of piezoelectric elements within a space surrounded by the central opening of the lower sealing plate.

In a preferable configuration of the manufacturing method according to the third aspect, the lower sealing plate is configured to include a partition wall that divides the central opening into a plurality of openings having a size that surrounds the corresponding piezoelectric element.

In order to achieve the third object, a fourth aspect of the present invention provides a manufacturing method of an ultrasonic transducer including a rigid substrate provided with a plurality of opening portions penetrating between an upper surface and a lower surface, a flexible resin film fixed to the upper surface of the substrate in such a way as to cover the plurality of opening portions, the same number of piezoelectric elements as the plurality of opening portions, the piezoelectric element being fixed to the upper surface of the flexible resin film in such a way that a middle portion thereof overlaps, in a plan view, the corresponding opening portion and a peripheral portion thereof overlaps, in a plan view, the rigid substrate, and a wiring structure including first and second wirings that are electrically connected to external and internal electrodes of the piezoelectric element, respectively, wherein the piezoelectric element includes a piezoelectric element main body made of a piezoelectric material, upper and lower electrodes provided on upper and lower surfaces of the piezoelectric element main body, respectively, the upper and lower electrodes forming the external electrode, the internal electrode dividing the piezoelectric element main body into upper and lower sides in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode, the manufacturing method including a rigid substrate forming step of preparing a rigid plate member having the same thickness as the rigid substrate and forming the plurality of opening portions in the rigid plate member to obtain the rigid substrate; a flexible resin film fixing step of fixing the flexible resin film to the upper surface of the rigid substrate so as to cover the plurality of opening portions; a lower sealing plate fixing step of preparing a lower sealing plate that includes a central opening of a size surrounding, in a plane view, all of the plurality of opening portions, and fixing the lower sealing plate to the upper surface of the flexible resin film in such a way that the central opening surrounds all of the plurality of opening portions; a piezoelectric element fixing step of fixing the plurality of piezoelectric elements to the upper surface of the flexible resin film by a first insulating resin material in such a way as to overlap, in a plan view, the plurality of opening portions, respectively; an insulating resin material setting step of setting a second insulating resin material in such a way as to cover the side surfaces of the plurality of piezoelectric elements within the central opening, and also cover the upper surfaces of the plurality of piezoelectric elements to form an insulating cover member; an electrode exposing step of forming, in the insulating cover member, an external electrode opening that integrally exposes at least a part of the lower electrode terminal and at least a part of the upper electrode, and an internal electrode opening that exposes at least a part of the internal electrode terminal without exposing the internal-electrode-terminal facing area; a conductive bonding material setting step of setting a first conductive bonding material in such a way as to integrally cover the parts of the lower electrode terminal and the upper electrode that are exposed through the external electrode opening, and setting a second conductive bonding material at the part of the internal electrode terminal that is exposed through the internal electrode opening; and a wiring structure setting step of setting the wiring structure in such a manner that a part of the first wiring comes into contact with the first conductive bonding material and a part of the second wiring comes into contact with the second conductive bonding material.

In order to achieve the third object, a fifth aspect of the present invention provides a manufacturing method of an ultrasonic transducer including a rigid substrate provided with a plurality of opening portions penetrating between an upper surface and a lower surface, a flexible resin film fixed to the upper surface of the substrate in such a way as to cover the plurality of opening portions, the same number of piezoelectric elements as the plurality of opening portions, the piezoelectric element being fixed to the upper surface of the flexible resin film in such a way that a middle portion thereof overlaps, in a plan view, the corresponding opening portion and a peripheral portion thereof overlaps, in a plan view, the rigid substrate, and a wiring structure including first and second wirings that are electrically connected to external and internal electrodes of the piezoelectric element, respectively, wherein the piezoelectric element includes a piezoelectric element main body made of a piezoelectric material, upper and lower electrodes provided on upper and lower surfaces of the piezoelectric element main body, respectively, the upper and lower electrodes forming the external electrode, the internal electrode dividing the piezoelectric element main body into upper and lower sides in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode, the manufacturing method including a rigid substrate forming step of preparing a rigid plate member having the same thickness as the rigid substrate and forming the plurality of opening portions in the rigid plate member to obtain the rigid substrate; a flexible resin film fixing step of fixing the flexible resin film to the upper surface of the rigid substrate so as to cover the plurality of opening portions; a piezoelectric element fixing step of fixing the plurality of piezoelectric elements to the upper surface of the flexible resin film by a first insulating resin material in such a way as to overlap the plurality of opening portions in a plan view, respectively; a lower sealing plate fixing step of preparing a lower sealing plate that includes a central opening of a size surrounding, in a plane view, all of the plurality of opening portions, and fixing the lower sealing plate to the upper surface of the flexible resin film in such a way that the central opening surrounds all of the plurality of opening portions; an insulating resin material setting step of setting a second insulating resin material in such a way as to cover the side surfaces of the plurality of piezoelectric elements within the central opening, and also cover the upper surfaces of the plurality of piezoelectric elements to form an insulating cover member; an electrode exposing step of forming, in the insulating cover member, an external electrode opening that integrally exposes at least a part of the lower electrode terminal and at least a part of the upper electrode, and an internal electrode opening that exposes at least a part of the internal electrode terminal without exposing the internal-electrode-terminal facing area; a conductive bonding material setting step of setting a first conductive bonding material in such a way as to integrally cover the parts of the lower electrode terminal and the upper electrode that are exposed through the external electrode opening, and setting a second conductive bonding material at the part of the internal electrode terminal that is exposed through the internal electrode opening; and a wiring structure setting step of setting the wiring structure in such a manner that a part of the first wiring comes into contact with the first conductive bonding material and a part of the second wiring comes into contact with the second conductive bonding material.

In order to achieve the third object, a sixth aspect of the present invention provides a manufacturing method of an ultrasonic transducer including a rigid substrate provided with a plurality of opening portions penetrating between an upper surface and a lower surface, a flexible resin film fixed to the upper surface of the substrate in such a way as to cover the plurality of opening portions, the same number of piezoelectric elements as the plurality of opening portions, the piezoelectric element being fixed to the upper surface of the flexible resin film in such a way that a middle portion thereof overlaps, in a plan view, the corresponding opening portion and a peripheral portion thereof overlaps, in a plan view, the rigid substrate, and a wiring structure including first and second wirings that are electrically connected to external and internal electrodes of the piezoelectric element, respectively, wherein the piezoelectric element includes a piezoelectric element main body made of a piezoelectric material, upper and lower electrodes provided on upper and lower surfaces of the piezoelectric element main body, respectively, the upper and lower electrodes forming the external electrode, the internal electrode dividing the piezoelectric element main body into upper and lower sides in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode, the manufacturing method including a rigid substrate forming step of preparing a rigid plate member having the same thickness as the rigid substrate and forming the plurality of opening portions in the rigid plate member to obtain the rigid substrate; a flexible resin film fixing step of fixing the flexible resin film to the upper surface of the rigid substrate so as to cover the plurality of opening portions; a lower sealing plate fixing step of preparing a lower sealing plate that has a thickness larger than the piezoelectric element and includes a central opening of a size surrounding, in a plane view, all of the plurality of opening portions, and fixing the lower sealing plate to the upper surface of the flexible resin film in such a way that the central opening surrounds all of the plurality of opening portions; an insulating resin material filling step of fill a space in the central opening with an insulating resin material; a piezoelectric element fixing step of arranging the plurality of piezoelectric elements on the upper surface of the flexible resin film within the insulating resin material so that the plurality of piezoelectric elements overlap, in a plan view, the plurality of opening portions, respectively, in a state that a part of the insulating resin material covers the upper surfaces of the plurality of piezoelectric elements, and fixing the plurality of piezoelectric elements to the flexible resin film by the insulating resin material; an electrode exposing step of forming, in a part of the insulating resin material that covers the upper surfaces of the plurality of piezoelectric elements to form an insulating cover member, an external electrode opening that integrally exposes at least a part of the lower electrode terminal and at least a part of the upper electrode and an internal electrode opening that exposes at least a part of the internal electrode terminal without exposing the internal-electrode-terminal facing area; a conductive bonding material setting step of setting a first conductive bonding material in such a way as to integrally cover the parts of the lower electrode terminal and the upper electrode that are exposed through the external electrode opening, and setting a second conductive bonding material at the part of the internal electrode terminal that is exposed through the internal electrode opening; and a wiring structure setting step of setting the wiring structure in such a manner that a part of the first wiring comes into contact with the first conductive bonding material and a part of the second wiring comes into contact with the second conductive bonding material.

In a preferable configuration of the manufacturing method according to any one of the fourth to sixth aspects, the electrode exposing step may be configured to emit laser beam onto portions of the insulating cover member where the external and internal electrode openings should be formed so as to form the external and internal electrode openings.

In a preferable configuration of the manufacturing method according to any one of the fourth to sixth aspects, the lower sealing plate may be configured to include a partition wall that divides the central opening into a plurality of openings having a size that surrounds the corresponding piezoelectric element.

### BRIEF DESCRIPTION OF THE DRAWINGS

FIG. 1 is a plan view of an ultrasonic transducer including a piezoelectric element according to a first embodiment of the present invention.

FIG. 2 is a partial vertical sectional view of the ultrasonic transducer taken along the line II-II in FIG. 1.

FIG. 3 is an enlarged view of a portion III in FIG. 2.

FIG. 4 is a cross-sectional view taken along the line IV-IV in FIG. 2.

FIG. 5 is an enlarged view of a portion V in FIG. 4.

FIGS. 6A to 6D are plan views of a rigid substrate, a flexible resin film, a plurality of piezoelectric elements and a lower sealing plate, respectively, which are components of the ultrasonic transducer. On the basis of the state shown in FIG. 2, the components shown in FIGS. 6A to 6D are laminated in this order from the bottom to the top.

FIGS. 7A to 7E are plan views of a cover layer, first and second wirings, base layer, an intermediate region of the first wiring and a back-surface-side cover layer, respectively, of a wiring structure that is a component of the ultrasonic transducer. On the basis of the state shown in FIG. 2, the components shown in FIGS. 7A to 7E are laminated in this order from the bottom to the top.

FIG. 8A is a plan view of the piezoelectric element according to the first embodiment, and FIG. 8B is a cross-sectional view taken along line the VIII-VIII in FIG. 8A.

FIG. 9A is a plan view of a piezoelectric element according to a first modified example of the first embodiment, and FIG. 9B is a cross-sectional view taken along line the IX-IX in FIG. 9A.

FIG. 10A is a plan view of a piezoelectric element according to a second modified example of the first embodiment, and FIG. 10B is a cross-sectional view taken along line the X-X in FIG. 10A.

FIG. 11A is a plan view of a piezoelectric element according to a third modified example of the first embodiment, and FIG. 11B is a cross-sectional view taken along line the XI-XI in FIG. 11A.

FIG. 12A is a plan view of a piezoelectric element according to a fourth modified example of the first embodiment, and FIG. 12B is a cross-sectional view taken along line the XII-XII in FIG. 12A.

FIG. 13A is a plan view of a piezoelectric element according to a fifth modified example of the first embodiment, and FIG. 13B is a cross-sectional view taken along line the XIII-XIII in FIG. 13A.

FIG. 14A is a plan view of a piezoelectric element according to a sixth modified example of the first embodiment, and FIG. 14B is a cross-sectional view taken along line the XIV-XIV in FIG. 14A.

FIG. 15A is a plan view of a piezoelectric element according to a seventh modified example of the first embodiment, and FIG. 15B is a cross-sectional view taken along line the XV-XV in FIG. 15A.

FIG. 16 is a plan view of the wiring structure in a state that a part of its component is omitted.

FIG. 17 is a bottom view of the wiring structure in a state that a part of its component is omitted.

FIGS. 18A to 18C are plan views of an upper sealing plate, a sound absorbing member and a reinforcing plate, respectively, which are components of the ultrasonic transducer. On the basis of the state shown in FIG. 2, the components shown in FIGS. 18A to 18C are laminated in this order from the bottom to the top.

FIG. 19 is a vertical sectional view of a state after a flexible resin film fixing step of a manufacturing method (hereinafter referred to as first manufacturing method) of the ultrasonic transducer including the piezoelectric element according to the first embodiment.

FIG. 20 is a vertical sectional view of a state after a lower sealing plate fixing step of the first manufacturing method.

FIG. 21 is a vertical sectional view of a state after an insulating resin material filling step of the first manufacturing method.

FIG. 22 is a vertical sectional view of a state after an insulating cover member setting step of the first manufacturing method.

FIG. 23 is an enlarged view of a portion XXIII in FIG. 22

FIG. 24 is a plan view of the piezoelectric element after the insulating cover member setting step.

FIG. 25 is a vertical sectional view of a state after an electrode exposing step of the first manufacturing method.

FIG. 26 is an enlarged view of a portion XXVI in FIG. 25.

FIG. 27 is a plan view of the piezoelectric element after the electrode exposing step.

FIG. 28 is a vertical sectional view of a state after a conductive bonding material setting step of the first manufacturing method.

FIG. 29 is an enlarged view of a portion XXIX in FIG. 28.

FIG. 30 is a vertical sectional view of a state after a wiring structure setting step of the first manufacturing method.

FIG. 31 is an enlarged view of a portion XXXI in FIG. 30.

FIG. 32 is a vertical sectional view of a state after an upper sealing plate installation step of the first manufacturing method.

FIG. 33 is a partial vertical sectional view of an ultrasonic transducer according to a second embodiment of the present invention.

FIG. 34 Is an Enlarged View of a Portion Xxxiv in FIG. 33.

FIG. 35 is a partial enlarged cross-sectional view of an ultrasonic transducer according to a modified example of the second embodiment.

FIG. 36 is a vertical sectional view of a state after a flexible resin film fixing step of a manufacturing method (hereinafter referred to as second manufacturing method) of the ultrasonic transducer according to the second embodiment.

FIG. 37 is a vertical sectional view of a state after a lower sealing plate fixing step of the second manufacturing method.

FIG. 38 is a vertical sectional view of a state after a piezoelectric element fixing step of the second manufacturing method.

FIG. 39 is a vertical sectional view of a state after an insulating resin material setting step of the second manufacturing method.

FIG. 40 is an enlarged view of a portion XXXX in FIG. 39.

FIG. 41 is a plan view of the piezoelectric element after the insulating resin material setting step.

FIG. 42 is an enlarged vertical sectional view of a part of a state after an electrode exposing step of the second manufacturing method.

FIG. 43 is a plan view of the piezoelectric element after the electrode exposing step.

FIG. 44 is a vertical sectional view of a state after a conductive bonding material setting step of the second manufacturing method.

FIG. 45 is an enlarged view of a portion XXXXV in FIG. 44.

FIG. 46 is a vertical sectional view of a state after a wiring structure setting step of the second manufacturing method.

FIG. 47 is an enlarged view of a portion XXXXVII in FIG. 46.

FIG. 48 is a vertical sectional view of a state after an upper sealing plate installation step of the second manufacturing method.

FIG. 49 is a vertical sectional view of a state after an insulating resin material filling step of the second manufacturing method.

FIG. 50 is a vertical sectional view of a state after a piezoelectric element fixing step of the second manufacturing method.

FIG. 51 is an enlarged view of a portion XXXXXI in FIG. 50.

FIG. 52 is a plan view of a piezoelectric element according to another embodiment of the present invention.

FIG. 53 is a plan view of a lower sealing plate provided in an ultrasonic transducer according to a modified example of the present invention.

FIG. 54 is a partial vertical sectional view of the ultrasonic transducer according to the modified example of the present invention, the ultrasonic transducer including the lower sealing plate shown in FIG. 53.

### EMBODIMENT FOR CARRYING OUT THE INVENTION

### First Embodiment

Hereinafter, one embodiment of a piezoelectric element according to the present invention is described with reference to the accompanying drawings.

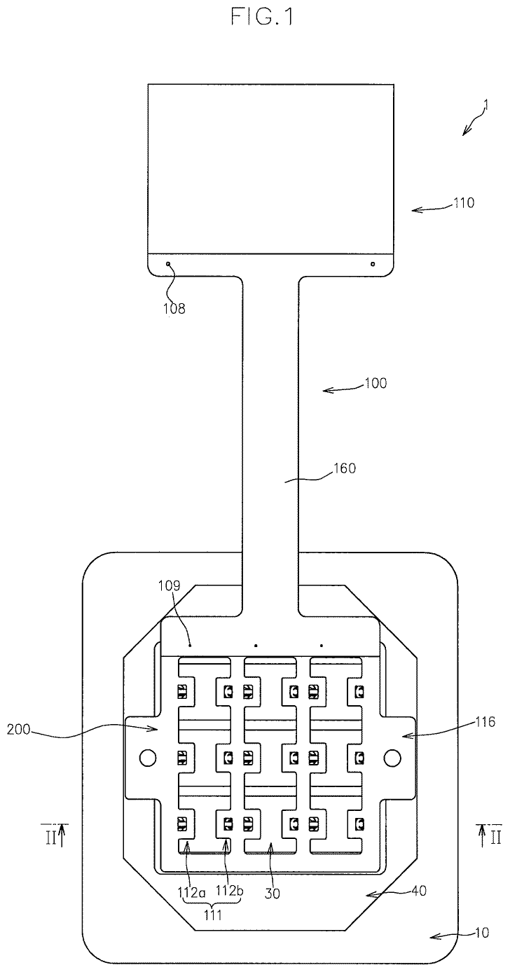

FIG. 1 illustrates a plan view of an ultrasonic transducer 1 to which a piezoelectric element 30 according to the present embodiment is applied.

Note that, in FIG. 1, for easy understanding, some of the constituent members of the ultrasonic transducer 1 are omitted.

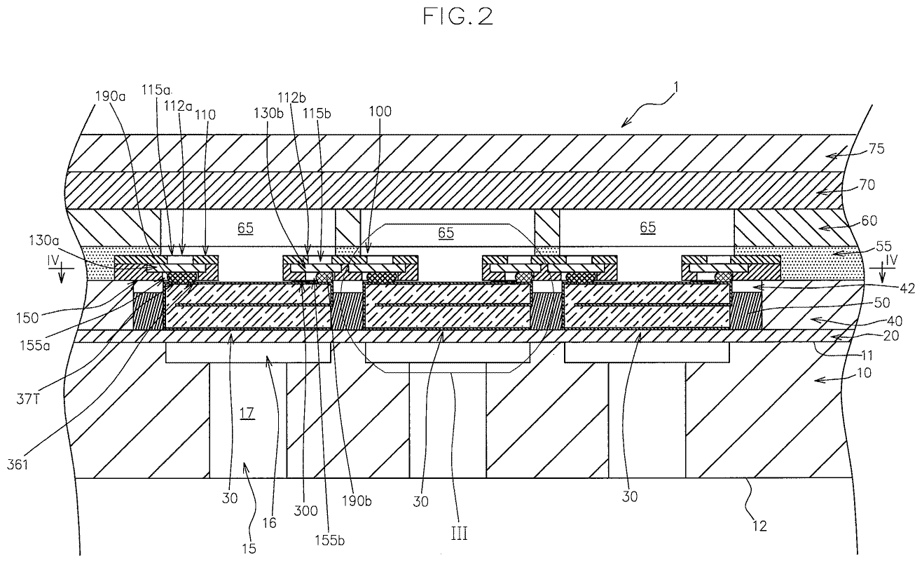

FIG. 2 illustrates a partial vertical sectional front view of the ultrasonic transducer 1 taken along the line II-II in FIG. 1.

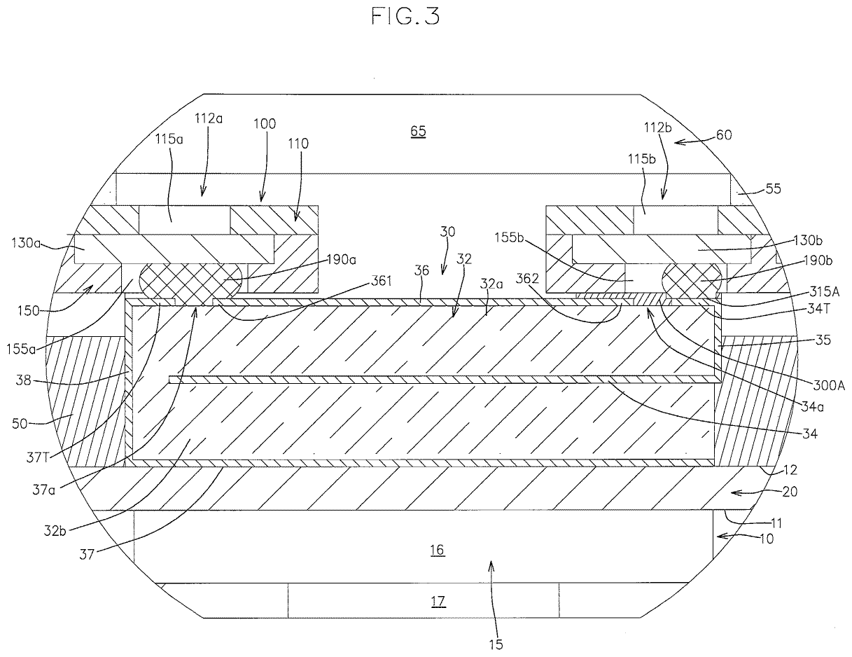

Further, FIG. 3 illustrated an enlarged view of a portion III in FIG. 2.

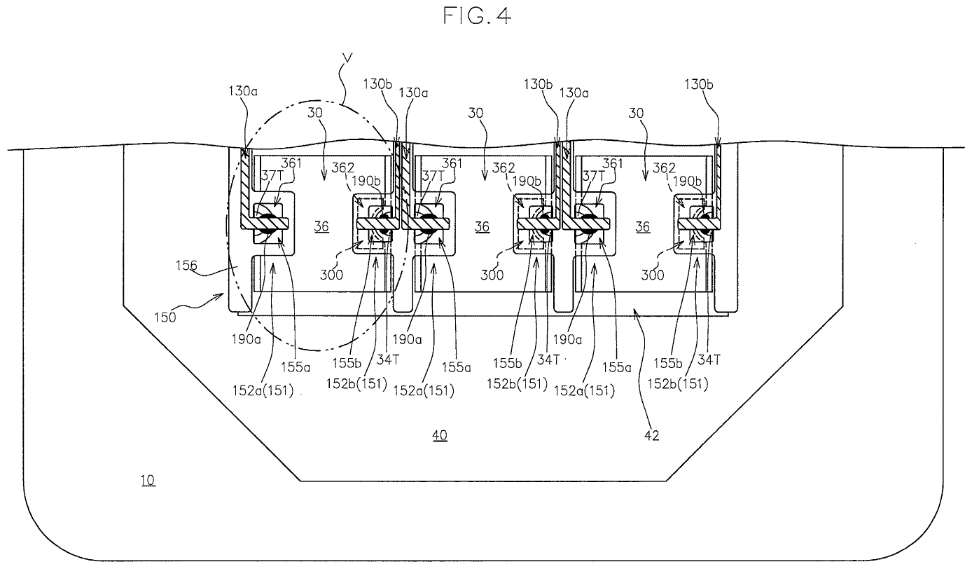

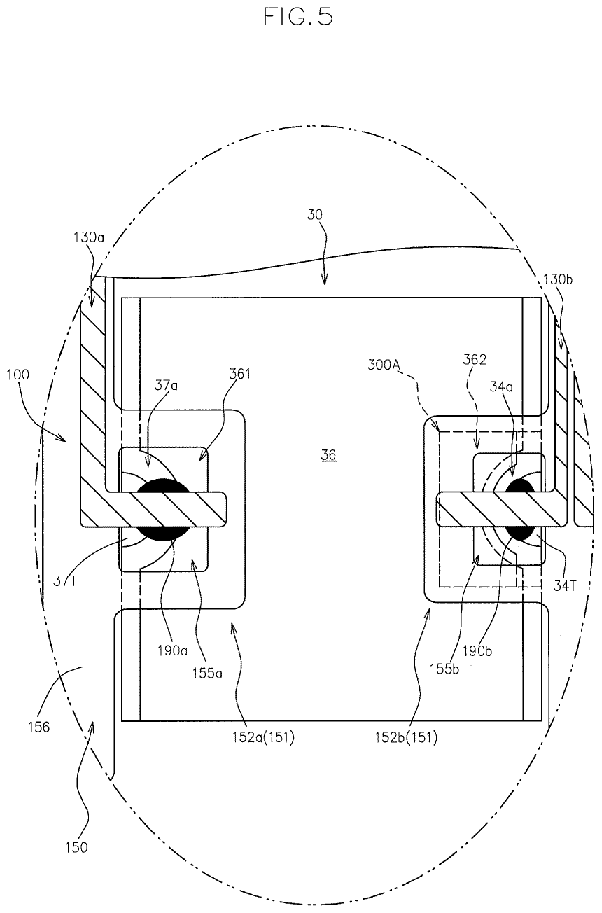

Still further, FIG. 4 illustrates a cross-sectional view taken along the line IV-IV in FIG. 2, and FIG. 5 illustrates an enlarged view of a portion V in FIG. 4.

First, the ultrasonic transducer 1 will be explained.

The ultrasonic transducer 1 emits a sonic wave in response to receipt of a supplied voltage, and generates a voltage in response to receipt of a sonic wave.

The ultrasonic transducer 1 includes a rigid substrate 10, a flexible resin film 20, a plurality of piezoelectric elements 30, a lower sealing plate 40 and a wiring structure 100 in order from the bottom to the top with reference to the cross-sectional view in FIG. 2.

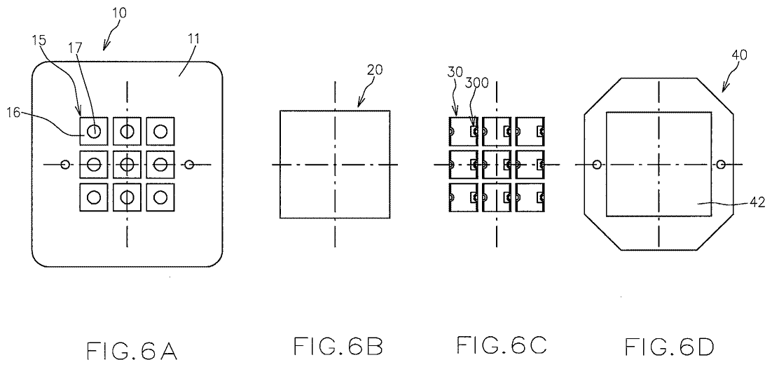

FIGS. 6A to 6D illustrate plan views of the rigid substrate 10, the flexible resin film 20, the plurality of piezoelectric elements 30, and the lower sealing plate 40, respectively.

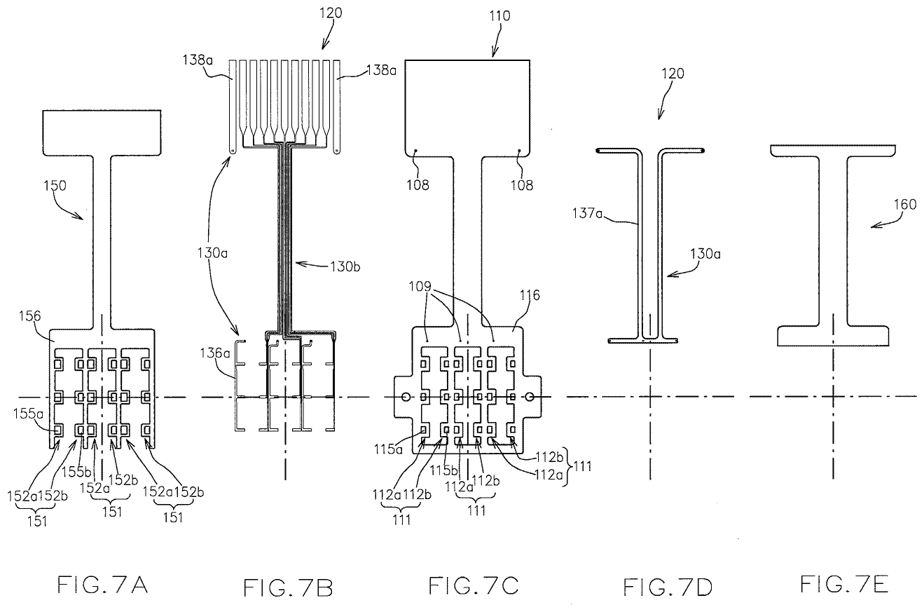

In addition, FIGS. 7A to 7E illustrate plan views of the wiring structure 100 for each constituent member.

Note that, in FIGS. 6A to 6D and FIGS. 7A to 7E, centerlines are drawn at the same position in a plan view in order to facilitate understanding of a relative positional relationship between the constituent members.

The rigid substrate 10 is formed of, for example, a metal substrate such as stainless steel having a thickness of 0.1 mm to 0.4 mm, carbon fiber reinforced plastics, ceramics, and the like.

As illustrated in FIG. 2 and FIG. 6A, the rigid substrate 10 is provided with a plurality of opening portions 15 penetrating between an upper surface 11 and a lower surface 12.

The opening portion 15 has a cavity portion 16 opened to the upper surface 11 of the rigid substrate 10, and a waveguide 17 having one end opened to a bottom surface of the cavity portion 16 and the other end opened to the lower surface 12 of the rigid substrate 10.

The cavity portion 16 has the same shape as the piezoelectric element 30 in a plan view.

In the present embodiment, the piezoelectric element 30 has a rectangular shape in a plan view, and therefore, the cavity portion 16 also has a rectangular shape in a plan view.

The opening width of the cavity portion 16 is set in such a way that a periphery of the piezoelectric element 30 overlaps the upper surface 11 of the rigid substrate 10 in a plan view in a state where the piezoelectric element 30 is placed via the flexible resin film 20.

The waveguide 17 has an opening width smaller than that of the cavity portion 16.

In the present embodiment, the waveguide 17 has a circular shape in a plan view.

In the present embodiment, as illustrated in FIG. 6A, the rigid substrate 10 is provided with the 3×3=nine opening portions 15, and the nine piezoelectric elements 30 are arranged in such a way as to overlap the nine opening portions 15 in a plan view, respectively, in a state of sandwiching the flexible resin film 20.

That is, in the ultrasonic transducer 1, the nine piezoelectric elements 30, each of which acts as a vibrating body, are arranged in a pattern of 3×3.

For example, in order to sharpen directivity of a radiated sound wave of the ultrasonic transducer 1, and increase an intensity of the radiated sound wave, vibrating bodies (piezoelectric elements 30) of the number more than 3×3 can be arranged.

The flexible resin film 20 is fixed to the upper surface 11 of the substrate 10 in such a way as to cover the plurality of opening portions 15.

The flexible resin film 20 is formed of, for example, an insulating resin such as polyimide having a thickness of 20 μm to 100 μm.

The flexible resin film 20 is fixed to the rigid substrate 10 by various methods such as an adhesive or thermocompression bonding.

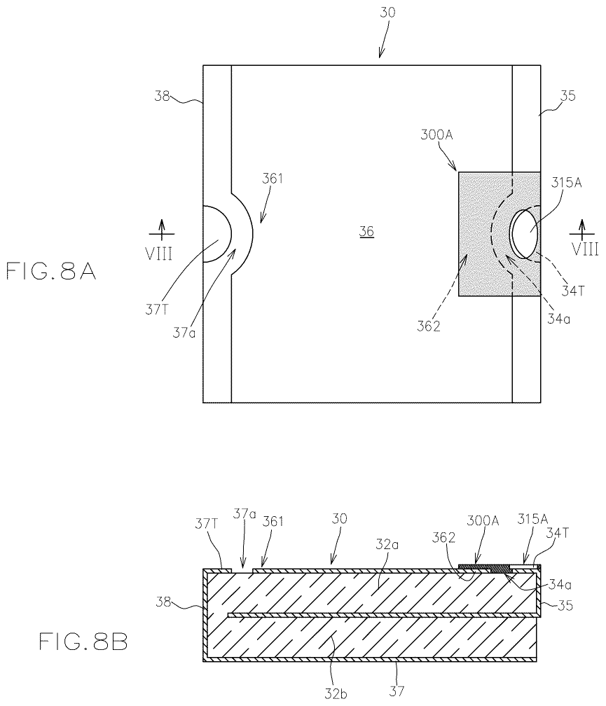

FIG. 8A illustrates a plan view of the piezoelectric element 30, and FIG. 8B illustrates a cross-sectional view taken along line the VIII-VIII in FIG. 8A.

The piezoelectric element 30 is fixed to an upper surface of the flexible resin film 20 in such a way that a middle portion thereof in a plan view overlaps the corresponding opening portion 15 (cavity portion 16), and a peripheral portion thereof in a plan view overlaps a portion of the rigid substrate 10 surrounding the corresponding opening portion 15 (cavity portion 16).

The piezoelectric element 30 is of a laminated type.

Specifically, the piezoelectric element 30 includes:
a piezoelectric element main body 32 made of a piezoelectric material such as lead zirconate titanate (PZT);
an internal electrode 34 for dividing the piezoelectric element main body 32 into a first piezoelectric portion 32a on an upper side and a second piezoelectric portion 32b on a lower side in the thickness direction;
an upper electrode 36 fixed to a part of an upper surface of the first piezoelectric portion 32a;
a lower electrode 37 fixed to a lower surface of the second piezoelectric portion 32b;
an internal electrode connector 35 having a base end side electrically connected to the internal electrode 34 and a tip end side forming an internal electrode terminal 34T that is arranged on the upper surface of the piezoelectric element main body 32 in such a manner that there is an internal-electrode-side gap 34a between the tip end side of the internal electrode connector 35 and the upper electrode 36; and
a lower electrode connector 38 having a base end side electrically connected to the lower electrode 37 and a tip end side forming a lower electrode terminal 37T that is arranged on the upper surface of the piezoelectric element main body 32 in such a manner that there is a lower-electrode-side gap 37a between the tip end side of the lower electrode connector 38 and the upper electrode 36.

The piezoelectric element 30 act as a vibrating body of the ultrasonic transducer 1.

For example, in a case where a driving voltage applied to the piezoelectric element 30 is set to have a frequency of 40 kHz, the piezoelectric element 30 may be set to have a resonance frequency of about 70 kHz and also have a quadrangular shape with one side of 3.0 mm in a plan view.

In this case, a layer thickness of the first and second piezoelectric portions 32a and 32b may be 0.1 mm to 0.2 mm.

The upper electrode 36, the lower electrode 37 and the internal electrode 34 may be formed of a metal film such as Au, AgPd, or Pt having a thickness of about 1 μm to 10 μm.

In the piezoelectric element 30, the upper electrode 36 and the lower electrode 37 form an external electrode, and the piezoelectric element 30 is configured to expand and contract, when a voltage is applied between the external electrode and the internal electrode 34.

That is, the first and second piezoelectric portions 32a and 32b have the same polarization direction in the thickness direction, whereby electric fields in opposite directions are applied to the first and second piezoelectric portions 32a and 32b by applying a predetermined voltage between the external electrode (the upper electrode 36 and the lower electrode 37) and the internal electrode 34 at predetermined frequency.

Note that, the upper electrode 36 and the lower electrode 37 are insulated from each other, and therefore, the polarization directions of the first and second piezoelectric portions 32a and 32b can be made the same by applying a voltage between the upper electrode 36 and the lower electrode 37, when the piezoelectric element 30 is produced.

In the piezoelectric element 30 having a configuration as described above, all of electrical connection of wirings (a first wiring 130a, which is explained below, in the wiring structure 100 in the present embodiment) to be connected to the external electrode (the upper electrode 36 and the lower electrode 37) to the upper electrode 36 and the lower electrode 37, and electrical connection of wirings (a second wiring 130b, which is also explained below, in the wiring structure 100 in the present embodiment) to be connected to the internal electrode 34 can be performed on an upper surface of the piezoelectric element 30 on one side in the thickness direction.

That is, in the piezoelectric element 30, as described above, the lower electrode terminal 37T is provided on an upper surface of the piezoelectric element main body 32 in a state of being away from the upper electrode 36 via or through the lower-electrode-side gap 37a, and the internal electrode terminal 34T is provided on the upper surface of the piezoelectric element main body 32 in a state of being away from the upper electrode 36 via or through the internal-electrode side gap 34a.

Therefore, as illustrated in FIG. 4, by providing a first conductive bonding material 190a in such a way as to integrally cover at least a part of the lower electrode terminal 37T and at least a part of a lower-electrode-terminal facing area 361 of the upper electrode 36 facing the lower electrode terminal 37T via or through the lower-electrode-side gap 37a, and then fixing the wiring (the first wiring 130a in the present embodiment) to be connected to the external electrode to the first conductive bonding material 190a, while providing a second conductive bonding material 190b in such a way as to cover at least a part of the internal electrode terminal 34T, and then fixing the wiring (the second wiring 130b in the present embodiment) to be connected to the internal electrode 34 to the second conductive bonding material 190b, electrical connection of the wiring (the first wiring 130a in the present embodiment) to be connected to the external electrode with respect to the external electrode, and electrical connection of the wiring (the second wiring 130b in the present embodiment) to be connected to the internal electrode 34 with respect to the internal electrode 34 can be performed on an upper surface of the piezoelectric element 30 on one side in the thickness direction.

As the first and second conductive bonding materials 190a and 190b, for example, a conductive adhesive or cream solder can be used.

As illustrated in FIGS. 4 and 7, the upper surface of the piezoelectric element 30 according to the present embodiment is provided with an insulating cover member 300A that integrally covers at least a part of the internal electrode terminal 34T, at least a part of an internal-electrode-terminal facing area 362 of the upper electrode 36 facing the internal electrode terminal 34T via or through the internal-electrode-side gap 34a, and an area of the internal-electrode-side gap 34a that is sandwiched by the internal electrode terminal 34T and the internal-electrode-terminal facing area 362.

The insulating cover member 300A may be formed by an insulating film made from, for example, an insulating resin such as a polyimide resin, a silicone resin, an epoxy resin or ceramics having a thickness of several um to several tens of um.

In a case where the insulating cover member 300A is formed by an insulating film of an epoxy resin or a silicone resin, the insulating cover member 300A can be efficiently formed by applying the resin at a predetermined area by a dispenser or a screen printing device or the like, and then heating the resin at a predetermined temperature (for example, 120 °C to 150 °C) to cure the same.

As illustrated in FIGS. 8A, 4 and 7, in the present embodiment, the insulating cover member 300A is configured to cover the whole of the internal electrode terminal 34T.

The insulating cover member 300A is provided with an internal electrode opening 315A (through hole or cutout) that exposes at least a part of the internal electrode terminal 34T without exposing the internal-electrode-terminal facing area 362.

According to a configuration as described above, it is possible to advantageously prevent short-circuiting between the external electrode (the upper electrode 36) and the internal electrode 34, while improving conversion efficiency between the voltage and the flexural vibration in the piezoelectric element 30 as much as possible.

That is, in order to improve conversion efficiency between the voltage and the flexural vibration of the piezoelectric element 30, it is necessary to increase the facing area of the external electrode and the internal electrode 34, that is, the facing area of the upper electrode 36 and the internal electrode 34, and the facing area of the internal electrode 34 and the lower electrode 37 as much as possible. Therefore, an increase in the facing area of the upper electrode 36 and the internal electrode 34 can be achieved by increasing the area of the upper electrode 36 as much as possible.

However, an increase in the area of the upper electrode 36 leads to narrowing of the internal-electrode-side gap 34a, and the risk of contact of the second conductive bonding material 190b, which electrically connects the internal electrode terminal 34T and the wiring (the second wiring 130b in the present embodiment) to be connected, with the upper electrode 36 increases due to a variation in the application amount and a variation in the application position of the second conductive bonding material 190b to be provided on the internal electrode terminal 34T.

This leads to lowering in the yield due to short-circuiting between the external electrode (the upper electrode 36) and the internal electrode 34, or lowering in the efficiency of an application operation of the second conductive bonding material 190b.

In this regard, in the present embodiment, as described above, at least a part of the internal electrode terminal 34T, the internal-electrode-terminal facing area 362 of the upper electrode 36 facing the internal electrode terminal 34T via or through the internal-electrode-side gap 34a, and the area of internal-electrode-side gap 34a that is sandwiched by the internal electrode terminal 34T and the internal-electrode-terminal facing area 362 are integrally covered by the insulating cover member 300A, and at least another part of the internal electrode terminal 34T is exposed through the internal electrode opening 315A formed in the insulating cover member 300A.

Therefore, even if the area of the upper electrode 36 is increased to improve conversion efficiency of the piezoelectric element 30, which may narrow the internal-electrode-side gap 34a, short-circuiting between the upper electrode 36 (i.e., the external electrode) and the internal electrode 34 due to contact of the second conductive bonding material 190b, which is applied to the area of the internal electrode terminal 34T that is exposed through the internal electrode opening 315A, with the upper electrode 36 can be advantageously prevented.

Further, even in a case where the second conductive bonding material 190b does not come into contact with the upper electrode 36 during an application operation of the second conductive bonding material 190b, narrowing of the internal-electrode-side gap 34a may cause a short circuit failure due to ion migration under the use environment conditions of the piezoelectric element 30 such as high temperature and high humidity. However, in the present embodiment, such kind of short circuit failure ion migration can also be advantageously prevented.

Furthermore, an edge of the internal electrode opening 315A efficiently prevents the second conductive bonding material 190b, which is applied to the area of the internal electrode terminal 34T that is exposed through the internal electrode opening 315A. Also, the application operation of the second conductive bonding material 190b can be performed with using the internal electrode opening 315A as a mark.

The internal electrode opening 315A is preferably formed by emitting laser beam from a laser device onto a desired portion of the insulating cover member 300A to thereby remove the desired portion from the insulating cover member 300A.

Since the internal electrode opening 315A is formed to have an opening diameter of, for example, 0.5 mm to 1 mm, and the internal electrode terminal 34T is formed to have a thickness of, for example, 0.1 mm to 0.2 mm, it is preferable to use a laser beam having a small spot diameter and a large absorption rate with respect to a target organic material (the insulating cover member 300A in this embodiment).

Specifically, third harmonic, which has a laser wavelength smaller than the fundamental wavelength among wavelengths of solid-state laser beam that is effective in processing resin material can be used.

Such laser beam makes it possible to condense the spot diameter to about wavelength of the laser beam when the laser beam is converged by a lens, whereby realizing fine removal.

The laser beam has a higher energy as the wavelength gets shorter. Since it is possible to perform photolysis, which directly cuts a molecular bond, with respect to a material having a weak molecular bond by using the laser beam having a higher energy, an effective processing with little heat influence can be realized.

As the laser beam having a large absorption rate with respect to a resign material, UV laser beam having third harmonic (355 nm) of solid-state laser beam, or UV leaser beam having fourth harmonics (266 nm) can be preferably used.

Alternatively, the internal electrode opening 315A can be formed by ion beam, electron beam or ion milling.

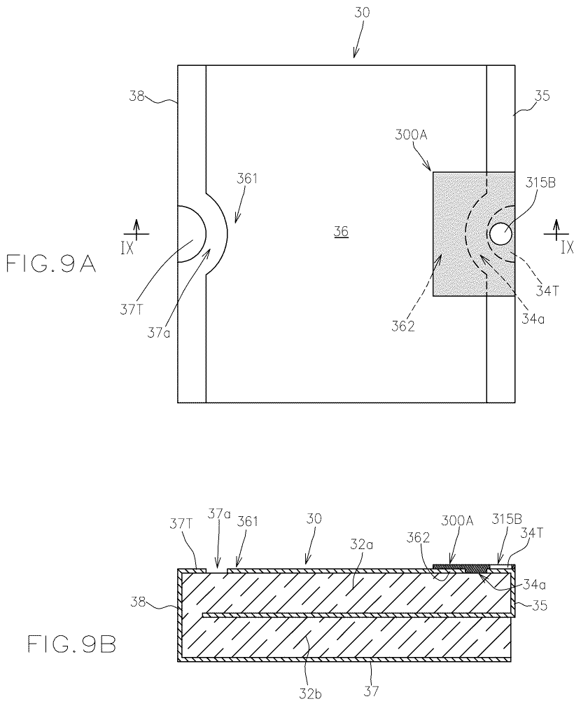

FIGS. 9A and 9B illustrate a plan view of a piezoelectric element 30 according to a first modified example of the present embodiment and a cross-sectional view taken along line the IX-IX in FIG. 9A, respectively.

As illustrated in FIGS. 8A and 8B, in the present embodiment, the internal electrode opening 315A is configured to expose at least a part of the internal electrode terminal 34T and also expose an area of the internal-electrode-side gap 34a that is adjacent to the exposed part of the internal electrode terminal 34T.

On the other hand, an internal electrode opening 315B in the first modified example is configured to expose only at least a part of the internal electrode terminal 34T and not to expose the internal-electrode-side gap 34a.

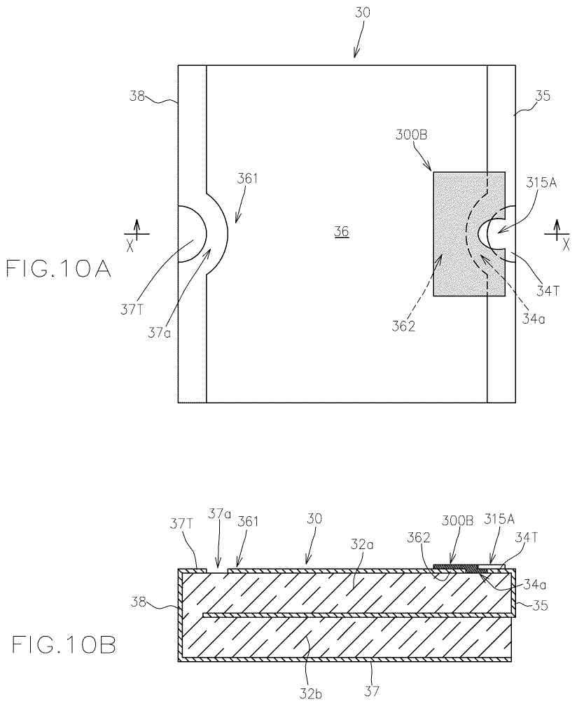

FIGS. 10A and 10B illustrate a plan view of a piezoelectric element 30 according to a second modified example of the present embodiment and a cross-sectional view taken along line the X-X in FIG. 10A, respectively.

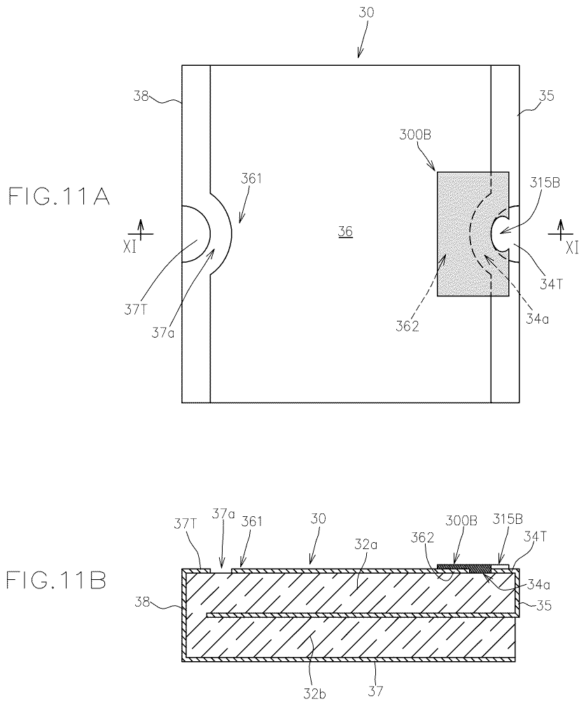

Furthermore, FIGS. 11A and 11B illustrate a plan view of a piezoelectric element 30 according to a third modified example of the present embodiment and a cross-sectional view taken along line the XI-XI in FIG. 11A, respectively.

In the present embodiment and the first modified example, the insulating cover member 300A is configured to cover a whole of the internal electrode terminal 34T.

On the other hand, the piezoelectric elements according to the second and third modified examples each include an insulating cover member 300B in place of the insulating cover member 300A.

The insulating cover member 300B is configured to integrally cover a part of the internal electrode terminal 34T, the internal-electrode-terminal facing area 362 of the upper electrode 36 facing the internal electrode terminal 34T via or through the internal-electrode-side gap 34a, and the area of internal-electrode-side gap 34a that is sandwiched by the internal electrode terminal 34T and the internal-electrode-terminal facing area 362.

The internal electrode opening 315A in the second modified example is configured to expose at least a part of the internal electrode terminal 34T and also expose an area of the internal-electrode-side gap 34a that is adjacent to the exposed part of the internal electrode terminal 34T. The internal electrode opening 315B in the third modified example is configured to expose only at least a part of the internal electrode terminal 34T without exposing the internal-electrode-side gap 34a.

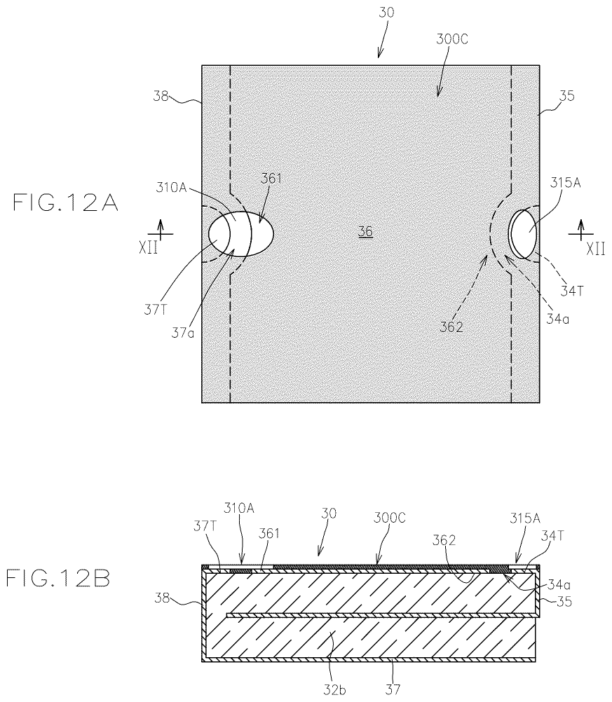

FIGS. 12A and 12B illustrate a plan view of a piezoelectric element 30 according to a fourth modified example of the present embodiment and a cross-sectional view taken along line the XII-XII in FIG. 12A, respectively.

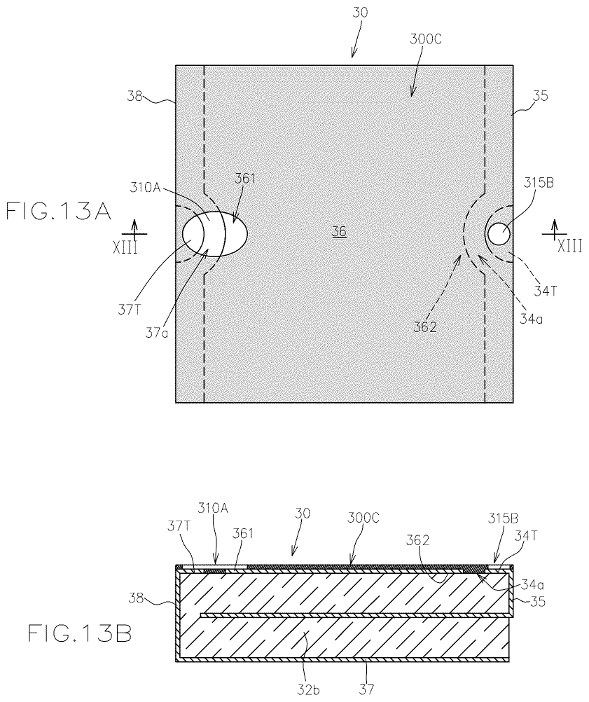

FIGS. 13A and 13B illustrate a plan view of a piezoelectric element 30 according to a fifth modified example of the present embodiment and a cross-sectional view taken along line the XIII-XIII in FIG. 13A, respectively.

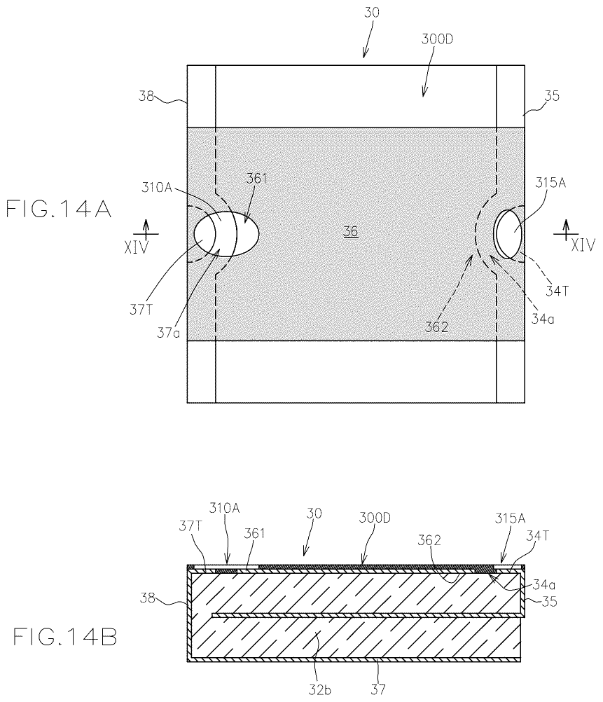

FIGS. 14A and 14B illustrate a plan view of a piezoelectric element 30 according to a sixth modified example of the present embodiment and a cross-sectional view taken along line the XIV-XIV in FIG. 14A, respectively.

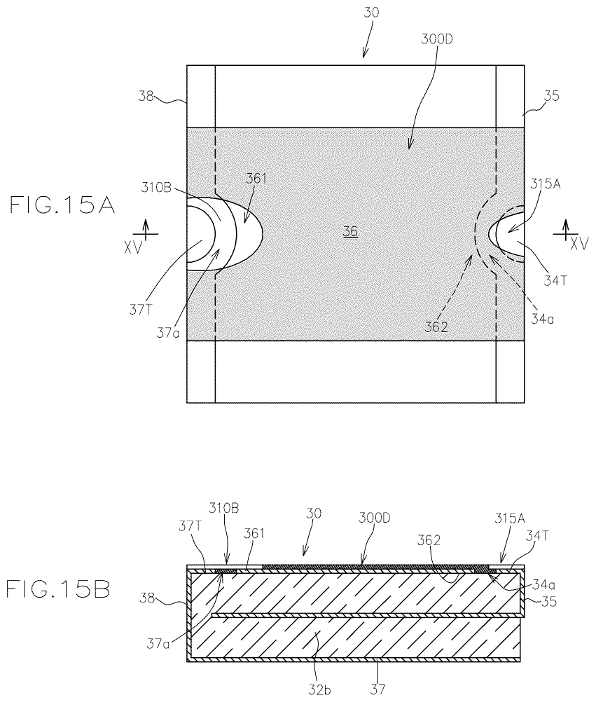

FIGS. 15A and 15B illustrate a plan view of a piezoelectric element 30 according to a seventh modified example of the present embodiment and a cross-sectional view taken along line the XV-XV in FIG. 15A, respectively.

The insulating cover members 300A in the present embodiment and the first modified example and the insulating cover members 300B in the second and third modified examples each are configured to integrally cover at least a part of the internal electrode terminal 34T, the internal-electrode-terminal facing area 362 of the upper electrode 36 facing the internal electrode terminal 34T via or through the internal-electrode-side gap 34a, and the area of internal-electrode-side gap 34a that is sandwiched by the internal electrode terminal 34T and the internal-electrode-terminal facing area 362 without covering the lower electrode terminal 37T, the lower-electrode-terminal facing area 361 of the upper electrode 36 facing the lower electrode terminal 37T via or through the lower-electrode-side gap 37a, and an area of the lower-electrode-side gap 37a that is sandwiched by the lower electrode terminal 37T and the lower-electrode-terminal facing area 361.

The insulating cover members 300C in the piezoelectric elements 30 according to the fourth and fifth modified examples and the insulating cover members 300D in the piezoelectric elements 30 according to the sixth and seventh modified examples each are configured to integrally cover at least a part of the internal electrode terminal 34T, the internal-electrode-terminal facing area 362 of the upper electrode 36 facing the internal electrode terminal 34T via or through the internal-electrode-side gap 34a, the area of internal-electrode-side gap 34a that is sandwiched by the internal electrode terminal 34T and the internal-electrode-terminal facing area 362, at least a part of the lower electrode terminal 37T, the lower-electrode-terminal facing area 361 of the upper electrode 36 facing the lower electrode terminal 37T via or through the lower-electrode-side gap 37a, and the area of the lower-electrode-side gap 37a that is sandwiched by the lower electrode terminal 37T and the lower-electrode-terminal facing area 361.

Specifically, the insulating cover members 300C in the piezoelectric elements 30 according to the fourth and fifth modified examples each are configured to cover a substantially whole of the upper surface of the piezoelectric element 30.

On the other hand, the insulating cover members 300D in the piezoelectric elements 30 according to the sixth and seventh modified examples each are configured to cover a part of the upper surface of the piezoelectric element 30.

In addition, in the fourth and sixth modified examples, the insulating cover members 300C, 300D each are provided with the internal electrode opening 315A and an external electrode opening 310A (through hole or cutout) that integrally exposes at least a part of the lower electrode terminal 37T and at least a part of the upper electrode 36.

In the fifth modified example, the insulating cover member 300C is provided with the internal electrode opening 315B and the external electrode opening 310A.

In the seventh modified example, the insulating cover member is provided with the internal electrode opening 315A and an external electrode opening 310B (through hole or cutout) that integrally exposes a whole of the lower electrode terminal 37T and at least a part of the upper electrode 36.

The wiring structure 100 is configured to transmit an applied voltage, which is supplied from the outside, to the plurality of piezoelectric elements 30.

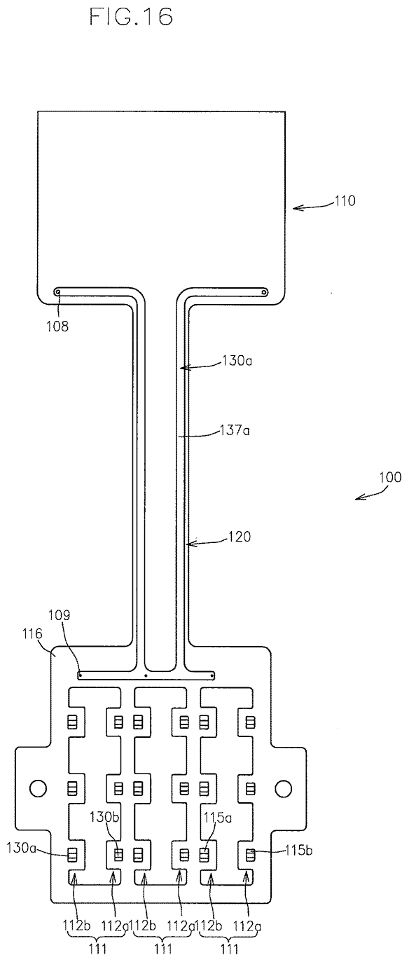

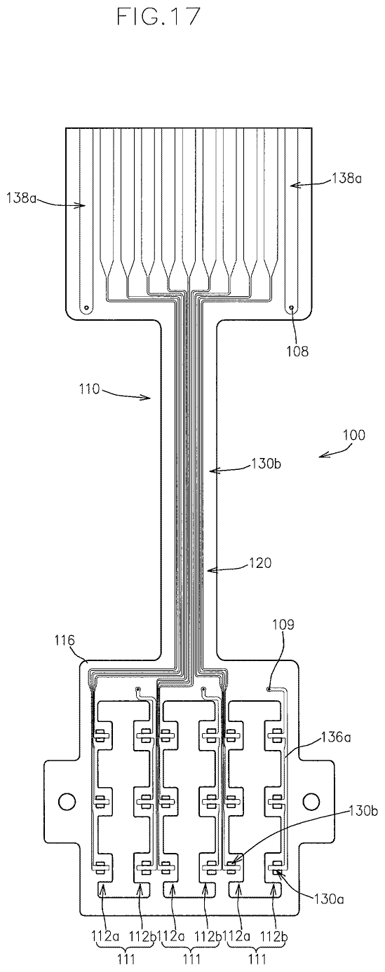

FIGS. 16 and 17 respectively illustrate a plan view (a view seen from the side opposite to or away from the piezoelectric element 30) and a bottom view (a view seen from the side of the piezoelectric element 30) of the wiring structure 100.

Note that, for easy understanding, a cover layer 150 described below is not illustrated in FIGS. 16 and 17.

As illustrated in FIGS. 7, 16, 17, and the like, the wiring structure 100 includes an insulating base layer 110, a conductive layer 120 including the first and second wirings 130a and 130b fixed to the base layer 110, and the insulating cover layer 150 for covering at least a part of the conductive layer 120 from a side opposite to or away from the base layer 110.

The base layer 110 and the cover layer 150 are formed of, for example, an insulating resin such as polyimide.

As illustrated in FIG. 16, the base layer 110 includes a plurality of base-side piezoelectric element overlapping portions 111 that partially overlap the plurality of piezoelectric elements 30 in a plan view, respectively, and a base-side tip end portion 116 that integrally holds the plurality of base-side piezoelectric element overlapping portions 111.

As described above, the ultrasonic transducer 1 includes the nine piezoelectric elements 30 of first to ninth piezoelectric elements 30. Therefore, the base layer 110 includes the nine base-side piezoelectric element overlapping portions 111 corresponding to the nine piezoelectric elements 30, respectively.

Similarly, as illustrated in FIG. 7A, the cover layer 150 includes a plurality of cover-side piezoelectric element overlapping portions 151 that partially overlap the plurality of piezoelectric elements 30 in a plan view, respectively, and a cover-side tip portion 156 that integrally holds the plurality of cover-side piezoelectric element overlapping portions 151.

The cover-side piezoelectric element overlapping portions 151 are also provided by the number corresponding to the number of the plurality of piezoelectric elements.

The piezoelectric element overlapping portion 151 of a piezoelectric-element-side insulating layer (the cover layer 150 (see FIG. 2) in the present embodiment) out of the base layer 110 and the cover layer 150, which is located on a side facing the piezoelectric element, includes an external-electrode tab area 152a that overlaps, in a plan view, an area integrally surrounding at least a part of the lower electrode terminal 37T and at least a part of the lower-electrode-terminal facing area 361, and an internal-electrode tab area 152b that overlaps, in a plan view, an area surrounding at least a part of the internal electrode terminal 34T.

As illustrated in FIGS. 2, 5, and 7, an external-electrode connection opening 155a and an internal-electrode connection opening 155b are provided in the external-electrode tab area 152a and the internal-electrode tab area 152b, respectively.

The first and second wirings 130a and 130b are formed of a conductive metal, for example, such as Cu.

The first and second wirings 130a and 130b can be formed by etching and removing an unnecessary portion of a Cu foil having a thickness of about 12 to 25 μm and being laminated on the base layer 110.

Preferably, Ni/Au-plating may be performed on an exposed portion of the first and second wirings 130a and 130b that forms Cu.

As illustrated in FIG. 5, a part of the first wiring 130a extends across or straddles the external-electrode connection opening 155a, and a part of the second wiring 130b extends across or straddles the internal-electrode connection opening 155b.

The wiring structure 100 is fixed to an upper surface of the lower sealing plate 40 in a state that the external-electrode connection opening 155a overlaps the area that integrally includes at least a part of the lower electrode terminal 37T and at least a part of the lower-electrode facing area 361 in a plan view, and the internal-electrode connection opening 155b overlaps at least a part of the internal electrode terminal 34T in a plan view, and the portion of the first wiring 130a extending across the external-electrode connection opening 155a is bonded to the first conductive bonding material 190a, and the portion of the second wiring 130b extending across the internal-electrode connection opening 155b is bonded to the second conductive bonding material 190b.

In the present embodiment, the piezoelectric element overlapping portion 111 of the insulating layer (the base layer 110 (see FIG. 2) in the present embodiment) out of the base layer 110 and the cover layer 150, which is located on a side away from the piezoelectric element 30, also includes an external-electrode tab area 112a that overlaps, in a plan view, an area integrally surrounding at least a part of the lower electrode terminal 37T and at least a part of the lower-electrode-terminal facing area 361, and an internal-electrode tab area 112b that overlaps, in a plan view, at least a part of the internal electrode terminal 34T, similarly to the piezoelectric-element-side insulating layer (the cover layer 150 in the present embodiment).

First and second access openings 115a and 115b are provided in the external-electrode tab area 112a and the internal-electrode tab area 112b, respectively.

Note that, in the present embodiment, the first wiring 130a is a common wiring that is integrally and electrically connected to the external electrodes of the plurality of piezoelectric elements 30, and the second wiring 130b is an individual wiring that is individually and electrically connected to each of the internal electrodes 34 of the plurality of piezoelectric elements 30.

The first wiring 130a is disposed on a surface of the base layer 110 on a side close to the piezoelectric element at a tip end side 136a to be electrically connected to the external electrodes of the plurality of piezoelectric elements 30, and a base end side 138a forming a connection terminal to the outside, and is disposed on a surface of the base layer 110 on a side opposite to or away from the piezoelectric element 30 at an intermediate portion 137a that interconnects the tip end 136a and the base end 138a.

The tip end side 136a and the intermediate portion 137a of the first wiring 130a are electrically connected to each other via a through-hole 109 formed in the base layer 110, and the intermediate portion 137a and the base end side 138a of the first wiring 130a are electrically connected to each other via a through-hole 108 formed in the base layer 110.

A portion of the first wiring 130a disposed on a surface of the base layer 110 on a side opposite to or away from the piezoelectric element 30 is covered with a back-surface-side cover layer 160 (see FIG. 6E).

The second wiring 130b is disposed on a surface of the base layer 110 on a side close to the piezoelectric element over the entire area.

As described above, in the ultrasonic transducer 1, as illustrated in FIG. 2, the wiring structure 100 is fixed to the lower sealing body 40 in a state that the cover layer 150 faces the piezoelectric element 30, and the base layer 110 is located on a side opposite to or away from the piezoelectric element 30 with respect to the conductive layer 120.

As illustrated in FIG. 2 and FIG. 6D, the lower sealing plate 40 includes a central opening 42 of a size that integrally surrounds the plurality of (nine in the present embodiment) opening portions 15 in the rigid substrate 10, and is fixed to the upper surface of the flexible resin film 20 in such a way that the central opening 42 integrally surrounds the plurality of opening portions 15 in a plan view.

As illustrated in FIG. 2, the lower sealing plate 40 has substantially the same thickness as the piezoelectric element 30, and is fixed to the upper surface of the flexible resin film 20 by an adhesive, thermocompression bonding, or the like.

The lower sealing plate 40 is preferably formed of a metal such as stainless steel, carbon fiber reinforced plastics, ceramics, and the like.

The lower sealing plate 40 seals the side of a piezoelectric element group constituted of the plurality of piezoelectric elements 30, and acts as a mount base to which the wiring structure 100 is fixed.

In the present embodiment, as illustrated in FIG. 2, an insulating resin material 50 is filled in a side portion of each of the plurality of piezoelectric elements 30 within a space surrounded by the central opening 42 of the lower sealing plate 40.

The insulating resin material 50 may be flexible resin material such as, for example, silicone.

By providing the insulating resin material 50, it is possible to advantageously block an external influence on the plurality of piezoelectric elements 30.

Further, vibration damping of the piezoelectric element 30 can be increased, and reverberation of a sound wave generated in a burst manner by the plurality of piezoelectric elements 30 can be suppressed, which can widen a distance detectable range of an object by a reflected wave as much as possible.

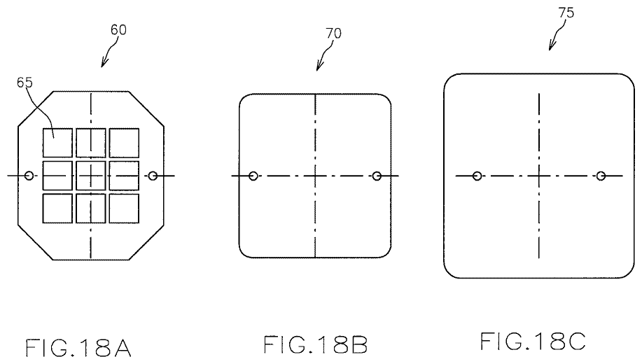

FIGS. 18A to 18C illustrate plan views of the upper sealing plate 60, the sound absorbing member 70, and the reinforcing plate 75, respectively.

Note that, in FIGS. 18A to 18C, in order to facilitate understanding of a relative positional relationship between the component members, centerlines are drawn at the same position in a plan view as in the case of FIGS. 6A to 6D and FIGS. 7A to 7E.

As illustrated in FIG. 2, the upper sealing plate 60 is fixed to an upper surface of the lower sealing plate 40 and the wiring assembly 100 via a flexible resin 55.

As illustrated in FIGS. 2 and 11A, the upper sealing plate 60 includes a plurality of (nine in the present embodiment) opening portions 65 corresponding to the plurality of piezoelectric elements 30, respectively.

By providing the upper sealing plate 60, it is possible to support and stabilize the wiring structure 100, while preventing an influence on a flexural vibration operation of the vibrating body as much as possible.

The upper sealing plate 60 is formed of, for example, a metal such as stainless steel having a thickness of 0.1 mm to 0.3 mm, carbon fiber reinforced plastics, ceramics, and the like.

The sound absorbing member 70 is fixed to an upper surface of the upper sealing plate 60 by adhesion or the like in such a way as to cover the plurality of opening portions 65 of the upper sealing plate 60.

The sound absorbing member 70 is formed of, for example, a silicone resin having a thickness of about 0.3 mm to 1.5 mm or another foamable resin.

By providing the sound absorbing member 70, it is possible to effectively suppress emission of a sound wave, which is generated by the piezoelectric element 30, toward the side opposite to or away from the side (the lower side in FIG. 2) to which the sound wave should be emitted.

The reinforcing plate 75 is fixed to an upper surface of the sound absorbing member 70 by adhesion or the like.

The reinforcing plate 75 is formed of, for example, a metal such as stainless steel having a thickness of about 0.2 mm to 0.5 mm, carbon fiber reinforced plastics, ceramics, and the like.

By providing the reinforcing plate 75, it is possible to prevent an external force from affecting the substrate 10 and the piezoelectric element 30 as much as possible.

Hereinafter, a manufacturing method of the ultrasonic transducer 1 is described.

The manufacturing method includes
a rigid substrate forming step of preparing a rigid plate member having the same thickness as the rigid substrate 10, and forming the plurality of opening portions 15 in the rigid plate member by etching or the like to obtain the rigid substrate 10; and
a flexible resin film fixing step of fixing the flexible resin film 20 to an upper surface of the rigid substrate 10 by an adhesive or thermocompression bonding in such a way as to cover the plurality of opening portions 15.

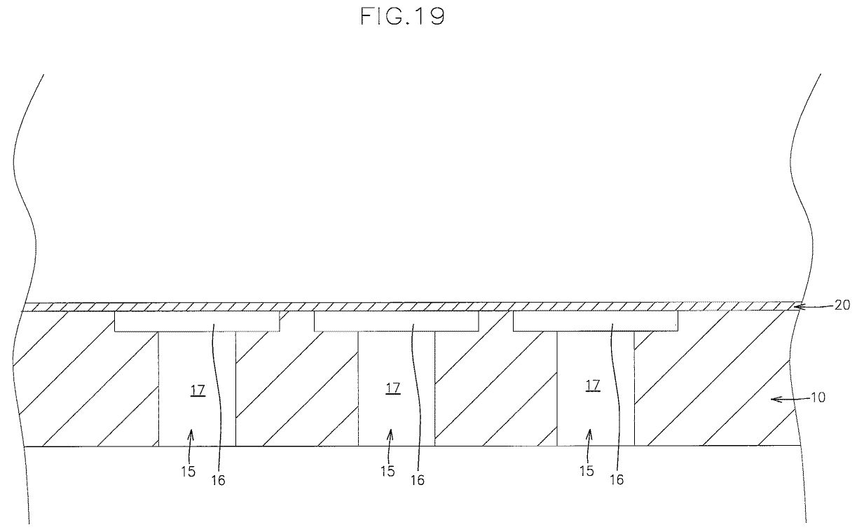

FIG. 19 illustrate a vertical sectional view of a preassembly after the flexible resin film fixing step.

In the present embodiment, the manufacturing method includes a lower sealing plate fixing step of preparing the lower sealing plate 40 having substantially the same thickness as the piezoelectric element 30 and including the central opening 42 of a size that integrally surrounds the plurality of opening portions 15 in the rigid substrate 10, and fixing the lower sealing plate 40 to the upper surface of the flexible resin 20 by an adhesive in such a way that the central opening 42 integrally surrounds the plurality of opening portions 15 in a plan view.

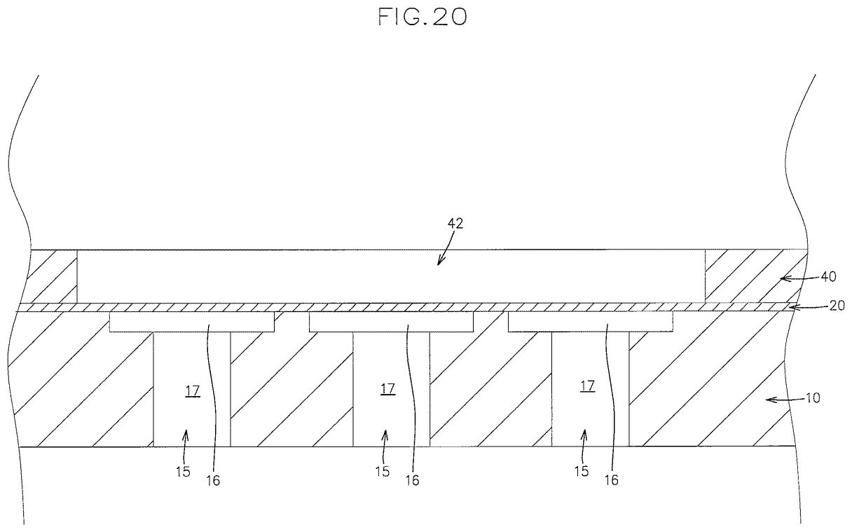

FIG. 20 illustrate a vertical sectional view of the preassembly after the lower sealing plate fixing step.

The manufacturing method further includes a piezoelectric element fixing step of fixing the plurality of piezoelectric elements 30 to the upper surface of the flexible resin film 20 by an insulating resin acting as adhesive in such a way as to overlap the plurality of opening portions 15 in a plan view, respectively.

In the present embodiment, the manufacturing method further includes an insulating resin material filling step of filling with the insulating resin material a side space of each of the plurality of piezoelectric elements 30 within a space surrounded by the central opening 42 of the lower sealing plate.

The insulating resin material is preferably flexible resin material such as silicone.

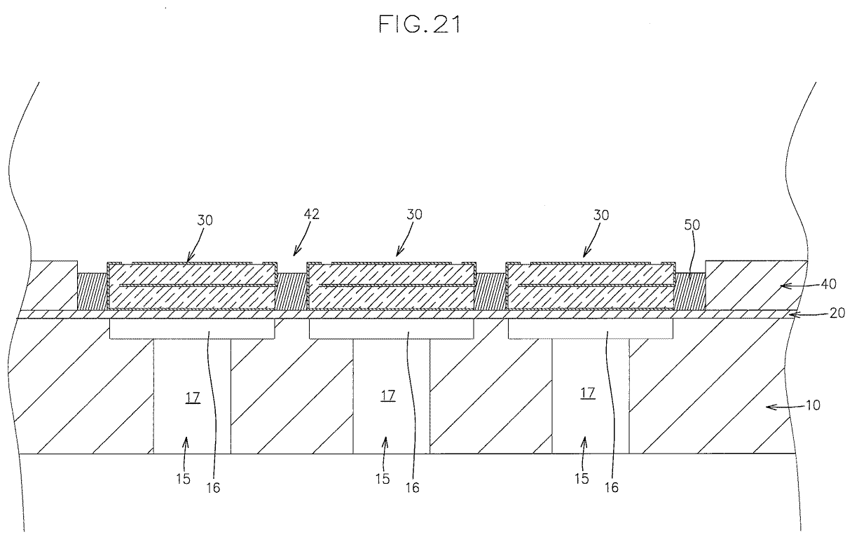

FIG. 21 illustrate a vertical sectional view of the preassembly after the insulating resin material filling step.

The insulating resin material filling step is configured to pour a thermosetting insulating resin such as silicone within the central opening 42 of the lower sealing plate 40 and then cure the resin by heating at the temperature of, for example, 100-150 °C for several tens of minutes.

The manufacturing method further includes an insulating cover member setting step of setting the insulating cover member 300A on the upper surface of the piezoelectric element 30 in such a manner as to integrally cover at least a part of the internal electrode terminal 34T, at least a part of an internal-electrode-terminal facing area 362 of the upper electrode 36 facing the internal electrode terminal 34T via or through the internal-electrode-side gap 34a, and an area of the internal-electrode-side gap 34a that is sandwiched by the internal electrode terminal 34T and the internal-electrode-terminal facing area 362.

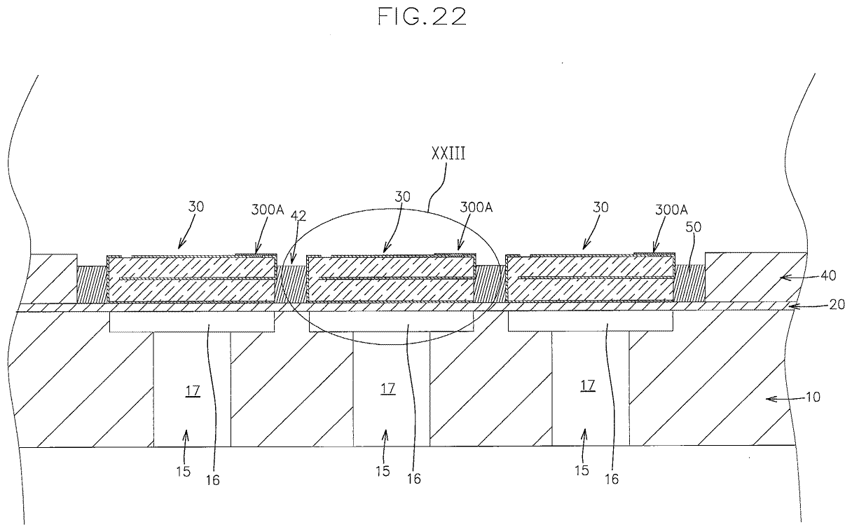

FIG. 22 illustrate a vertical sectional view of the preassembly after the insulating cover member setting step.

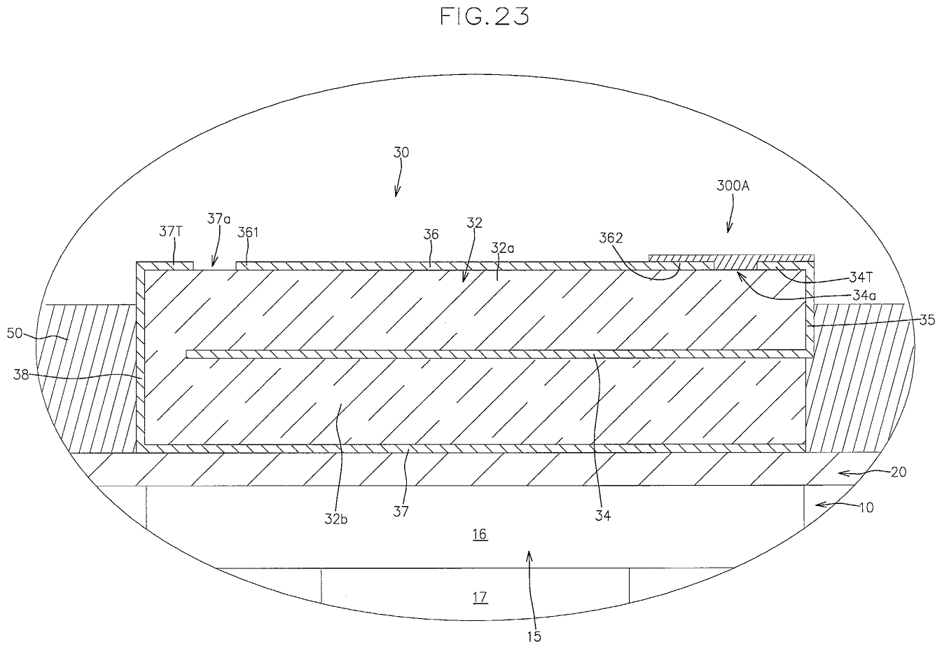

FIG. 23 illustrated an enlarged view of a portion XXIII in FIG. 22.

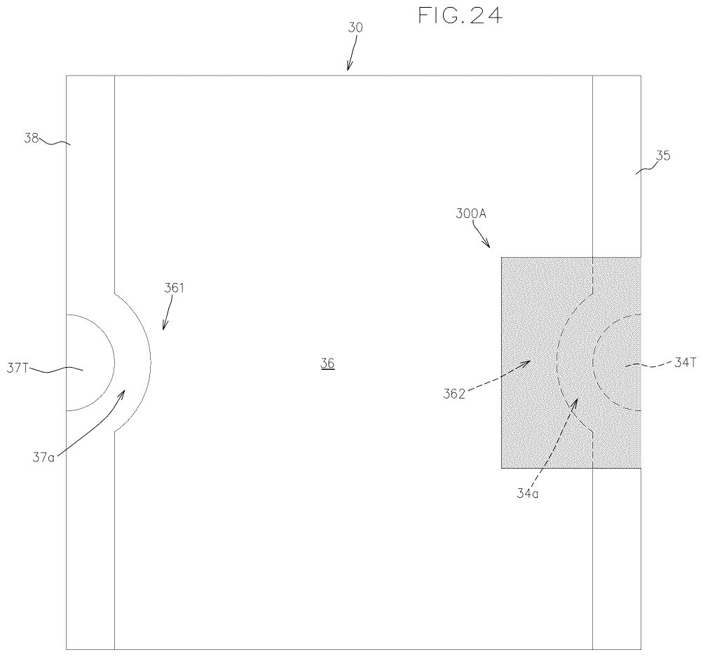

Further, FIG. 24 illustrates a plan view of the piezoelectric element 30 after the insulating cover member setting step.

As illustrated in FIGS. 22 to 24, the manufacturing method is configured to use the insulating cover member 300A. Alternatively, it is possible to use any one of the insulating cover members 300B to 300D.

For example, the insulating cover member 300A can be efficiently formed by applying, by a dispenser or a screen printing device or the like, an epoxy resin or a silicone resin at a predetermined area, and then heating the resin at a predetermined temperature (for example, 120 °C to 150 °C) to cure the same.

The manufacturing method further includes an electrode exposing step of forming the internal electrode opening 315A (or 315B) that exposes at least a part of the internal electrode terminal 34T without exposing the internal-electrode-terminal facing area 362.

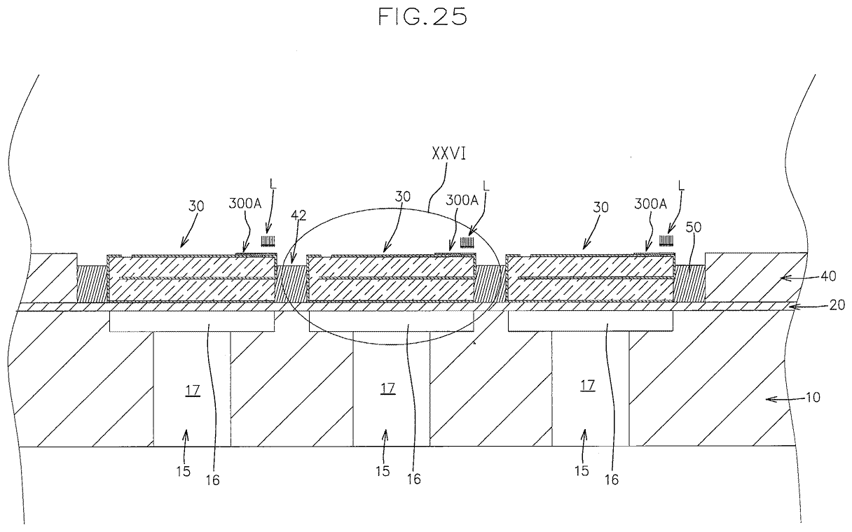

FIG. 25 illustrate a vertical sectional view of the preassembly after the electrode exposing step.

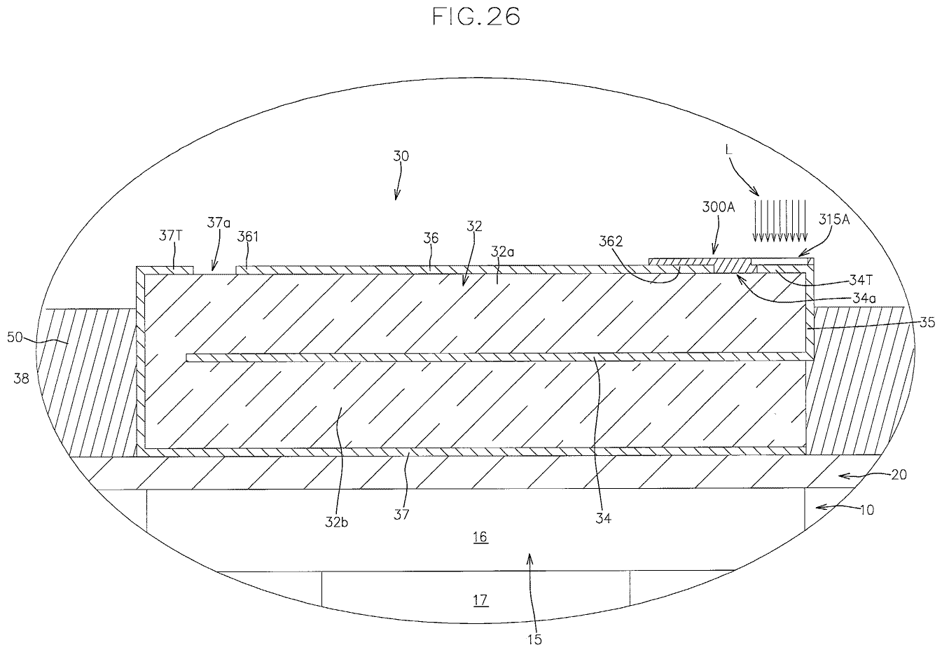

FIG. 26 illustrated an enlarged view of a portion XXVI in FIG. 25.

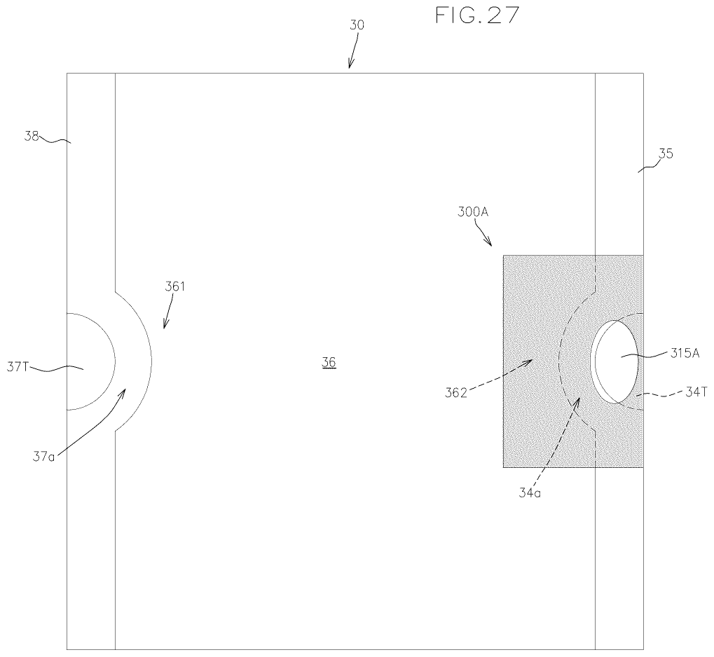

Further, FIG. 27 illustrates a plan view of the piezoelectric element 30 after the electrode exposing step.

As illustrated in FIG. 26 or the like, in the present embodiment, the electrode exposing step is configured to emit laser beam L onto a portion of the insulating cover member 300A where the internal electrode opening 315A should be formed so as to remove the portion from the insulating cover member 300A to form the internal electrode opening 315A.

Alternatively, it is possible to form the internal electrode opening 315A by means of ion beam, electron beam or ion milling.

In a case where the insulating cover member setting step is configured to set the insulating cover members 300C (FIGS. 12 and 13) or the insulating cover members 300D (FIGS. 14 and 15), the electrode exposing step is configured to form the internal electrode opening 315A and also form the external electrode opening 310A that integrally exposes at least a part of the lower electrode terminal 37T and at least a part of the upper electrode 36.

The external electrode opening 310A is formed by the same method as that of the internal electrode opening 315A.

The manufacturing method further includes a conductive bonding material setting step of setting the first conductive bonding material 190a in such a way as to integrally cover at least a part of the lower electrode terminal 37T and at least a part of a lower-electrode-terminal facing area 361 of the upper electrode 36 facing the lower electrode terminal 37T via or through the lower-electrode-side gap 37a, and setting the second conductive bonding material 190b at an area of the internal electrode terminal 34T that is exposed through the internal electrode opening 315A.

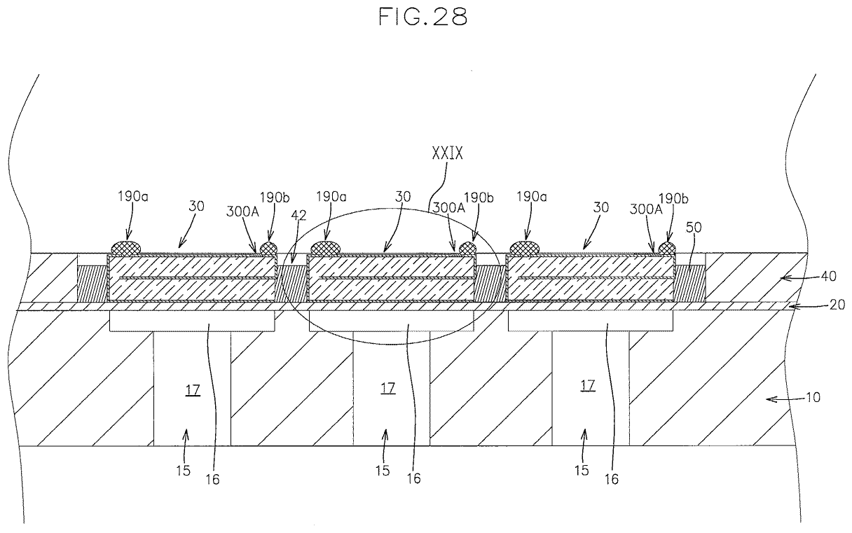

FIG. 28 illustrate a vertical sectional view of the preassembly after the conductive bonding material setting step.

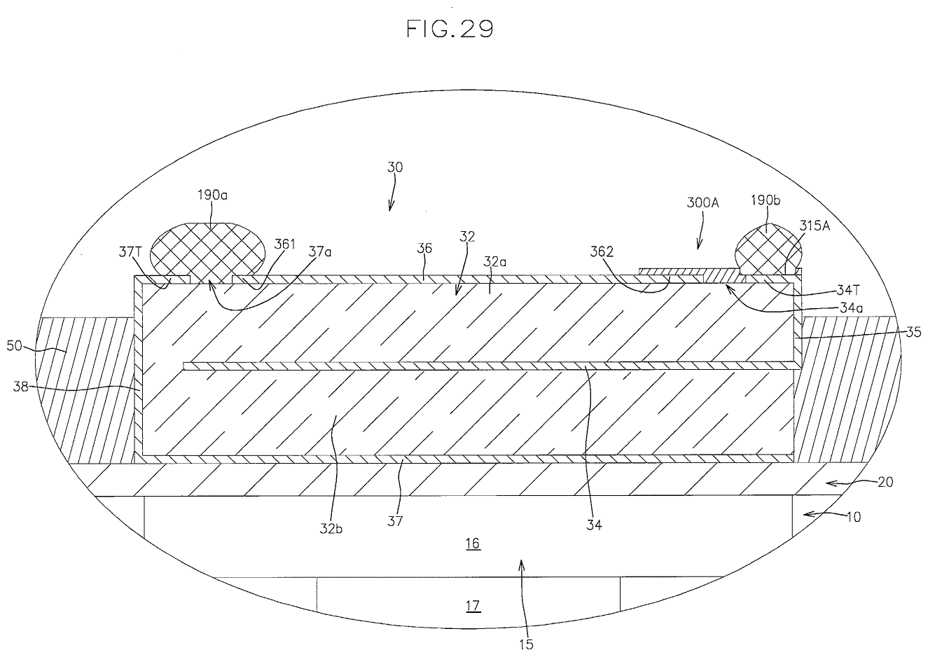

FIG. 29 illustrated an enlarged view of a portion XXIX in FIG. 28.

In a case where the insulating cover members 300C or 300D is used and the insulating cover members 300C, 300D is formed with the corresponding external electrode opening 310A, 310B, the first conductive bonding material 190a is set within the corresponding external electrode opening 310A, 310B.

The manufacturing method further includes a wiring structure setting step of setting the wiring structure 100 in such a manner that a part of the first wiring 130a comes into contact with the first conductive bonding material 190a and a part of the second wiring 130b comes into contact with the second conductive bonding material 190b.

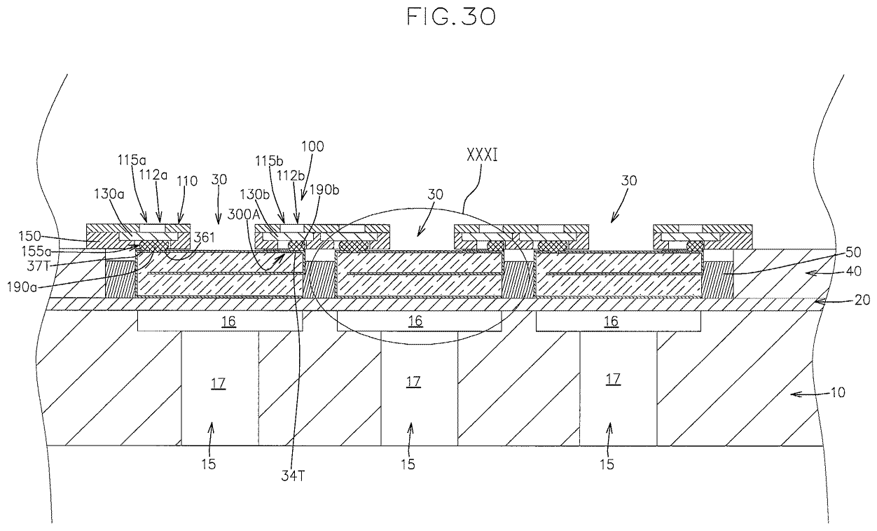

FIG. 30 illustrate a vertical sectional view of the preassembly after the wiring structure setting step.

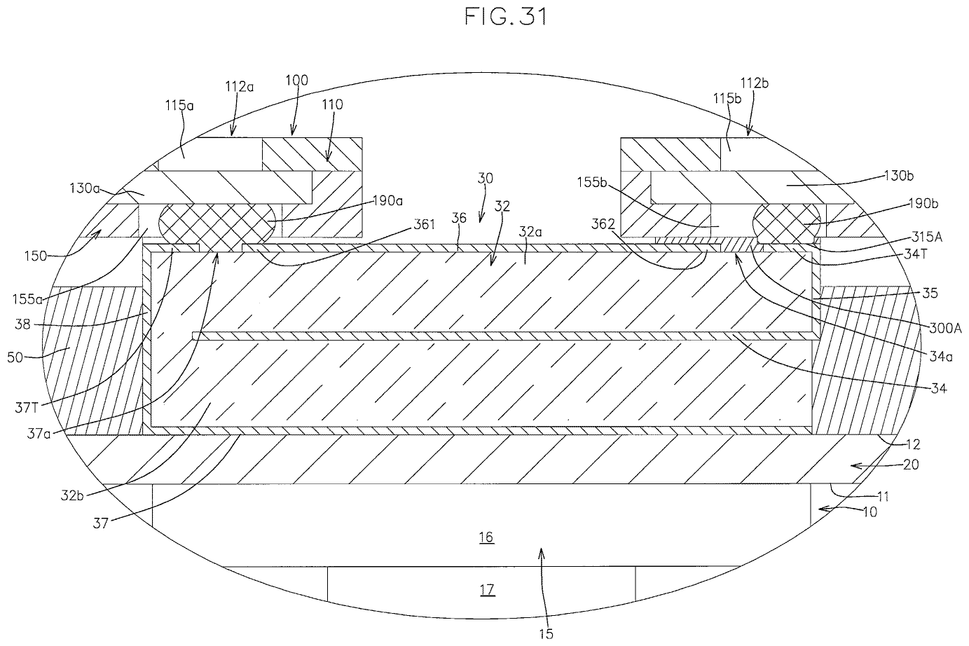

FIG. 31 illustrated an enlarged view of a portion XXXI in FIG. 30.

In the present embodiment, the wiring structure setting step is configured so as to fix the wiring structure 100 to the lower sealing plate 40 by an insulating adhesive (not shown) in such a manner that the portion of the first wiring 130a extending across the external-electrode connection opening 155a comes in contact with the first conductive bonding material 190a, and the portion of the second wiring 130b extending across the internal-electrode connection opening 155b comes in contact with the second conductive bonding material 190b.

The insulating adhesive that fixes the wiring structure 100 to the lower sealing plate 40 may be, for example, a thermosetting insulating adhesive.

The first and second conductive bonding materials 190a and 190b may be, for example, a thermosetting conductive adhesive or cream solder, and be applied at predetermined areas by means of a dispenser, a screen printing device or a transfer device or the like.

The wiring structure setting step is configured to include a heating process that cures the thermosetting insulating adhesive and the first and second conductive bonding materials 190a, 190b while arranging the wiring structure 100 at the predetermined position.

A heating temperature of the heating process may be approximate 120°C to 150 °C in a case where the first and second conductive bonding materials 190a, 190b each are thermosetting conductive adhesives, and be approximate 230 °C to 260 °C in a case where the first and second conductive bonding materials 190a, 190b each are cream solders. The cream solder is heated to be melt and cooled down from the melted condition to be cured.

Although, in the manufacturing method, the lower sealing plate fixing step is performed after the flexible resin film fixing step and before the piezoelectric element fixing step, the lower sealing plate fixing step can be performed at an arbitrary timing after the flexible resin film fixing step and before the wiring structure setting step.

Although, in the manufacturing method, the insulating resin material filling step is performed after the piezoelectric element fixing step and before the insulating cover member setting step, the insulating resin material filling step can be performed at an arbitrary timing after the lower sealing plate fixing step and the piezoelectric element fixing step and before the wiring structure setting step.

The manufacturing method further includes an upper sealing plate installation step of installing the upper sealing plate 60 after the wiring structure setting step.

The upper sealing plate installation step includes a process of applying a thermosetting flexible resin such as a silicone resin to an upper surface of the wiring structure 100, a process of arranging the upper sealing plate 60 on the flexible resin, and a process of curing the flexible resin by heating at, for example, about 100 °C to 150 °C for several tens of minutes.

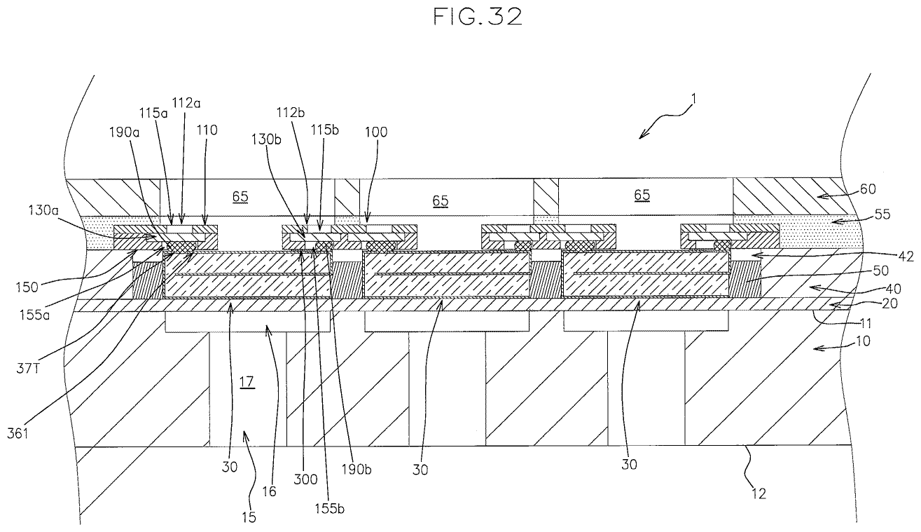

FIG. 32 illustrate a vertical sectional view of the preassembly after the upper sealing plate installation step.

The manufacturing method further includes a sound absorbing member installation step and a reinforcing plate installation step (see FIG. 2) after the upper sealing plate installation step.

The sound absorbing member installation step includes a process of applying a thermosetting insulating adhesive to an upper surface of the upper sealing plate 60, a process of disposing the sound absorbing member 70 such as a silicone resin or another foamable resin on the thermosetting insulating adhesive, and a process of curing the thermosetting insulating adhesive by heating at, for example, about 120 °C to 150 °C for several tens of minutes.

The reinforcing plate installation step includes a process of applying a thermosetting insulating adhesive to an upper surface of the sound absorbing member 70, a process of disposing the reinforcing plate 75 on the thermosetting insulating adhesive, and a process of curing the thermosetting insulating adhesive by heating at, for example, about 120 °C to 150 °C for several tens of minutes.

### Second Embodiment

Hereinafter, another embodiment of the ultrasonic transducer according to the present invention is described with reference to the accompanying drawings.

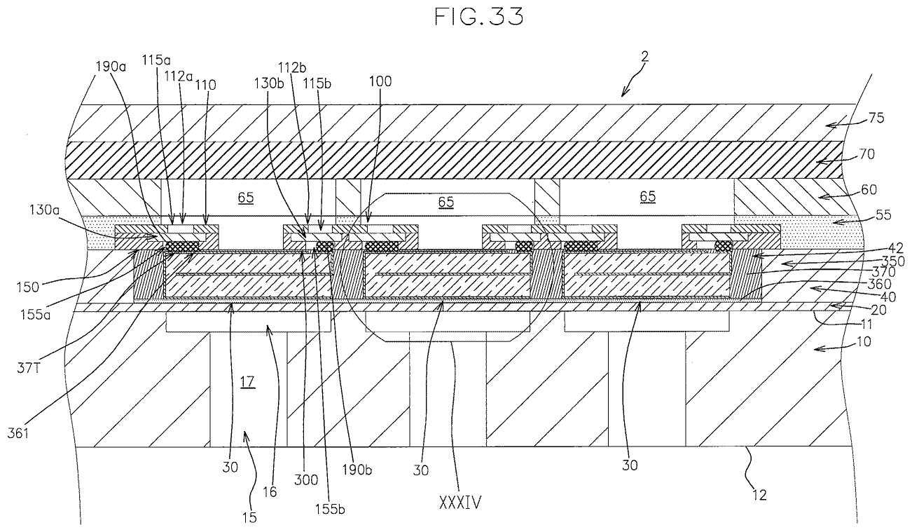

FIG. 33 illustrates a partial vertical sectional front view of the ultrasonic transducer 2 according to the present embodiment.

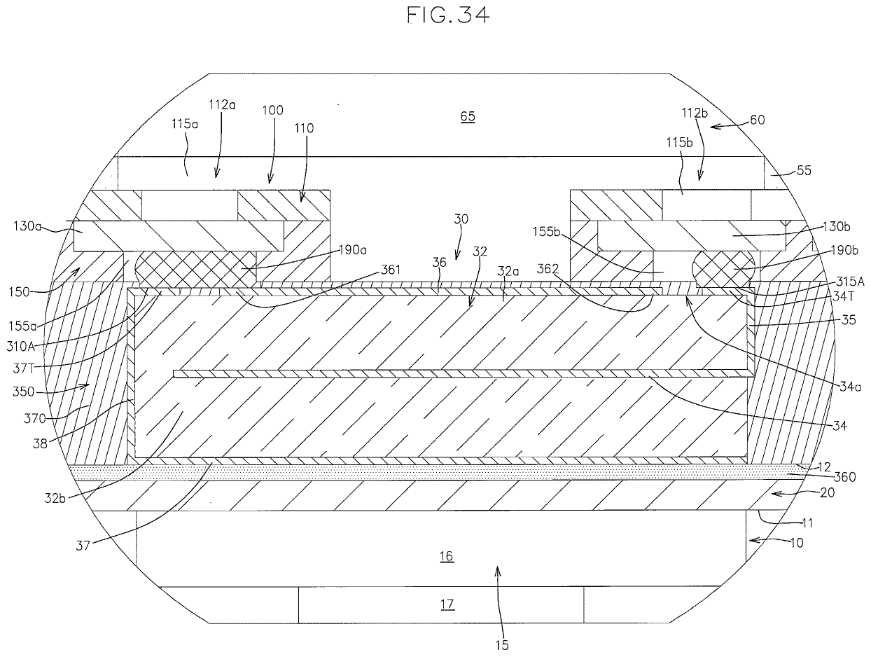

FIG. 34 illustrated an enlarged view of a portion XXXIV in FIG. 33.

In the drawings, the same reference numerals are applied to the same components as those in the first embodiment, and the description thereof will be omitted as appropriate.

As illustrated in FIGS. 33 and 34, the ultrasonic transducer 2 includes the rigid substrate 10, the flexible resin film 20, the lower sealing plate 40, the plurality of piezoelectric elements 30, an insulating resin material 350 and the wiring structure 100.

The plurality of piezoelectric elements 30 are arranged on the upper surface of the flexible resin film 20 within the central opening 42 in such a way as to overlap the plurality of opening portions 15 in a plan view, respectively.

The insulating resin material 350 is provided in such a way as to be interposed between the lower surface of the plurality of piezoelectric elements 30 and the flexible resin film 20, and also cover the side surfaces and the upper surfaces of the plurality of piezoelectric elements 30.

As illustrated in FIG. 34, in the present embodiment, the insulating resin material 350 includes a first insulating resin material 360 that fixes the lower surface of the piezoelectric element 30 to the flexible resin film 20, and a second insulating resin material 370 that covers the side surfaces and the upper surface of the piezoelectric element 30.

The second insulating resin material may be, for example, a flexible resin material such as a silicone resin.

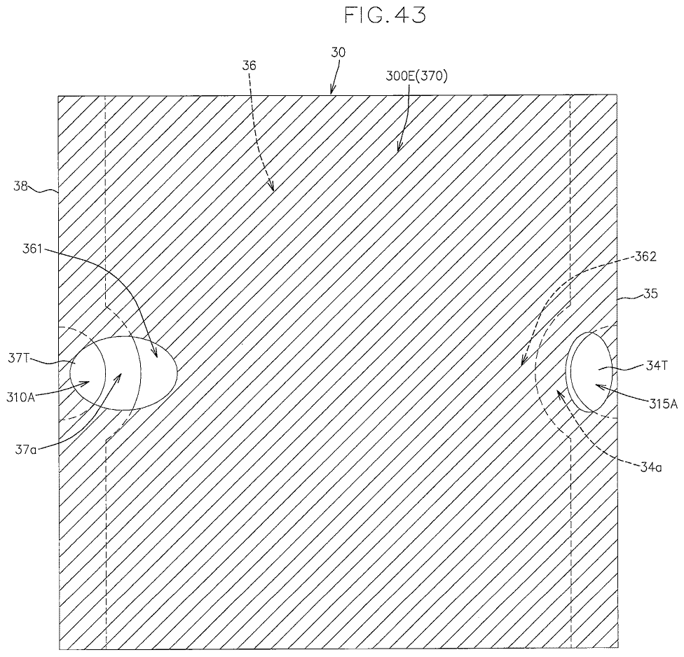

As illustrated in FIG. 34 (and FIG. 43 or the like mentioned below), a portion of the insulating resin material 350 (the second insulating material 370 in the present embodiment) is provided with the external electrode opening 310A (or 310B) that integrally exposes at least a part of the lower electrode terminal 37T and at least a part of the upper electrode 36, and the internal electrode opening 315A that exposes at least a part of the internal electrode terminal 34T without exposing the internal-electrode-terminal facing area 362.

In the same manner as that of the ultrasonic transducer 1 according to the first embodiment, the wiring structure 100 is fixed to the lower sealing plate 40 in a state that the first wiring 130a is electrically connected by the first conductive bonding material 190a to the lower electrode terminal 37T and the upper electrode 36 that are exposed through the external electrode opening 310A, and the second wiring 130b is electrically connected by the second conductive bonding material 190b to the internal electrode terminal 34T that is exposed through the internal electrode opening 315A.

Although, as explained above, the insulating resin material 350 includes the first insulating resin material 360 and the second insulating resin material 370 in the present embodiment, an insulating resin material 350B made of a single material can be provided in place of the insulating resin material 350.

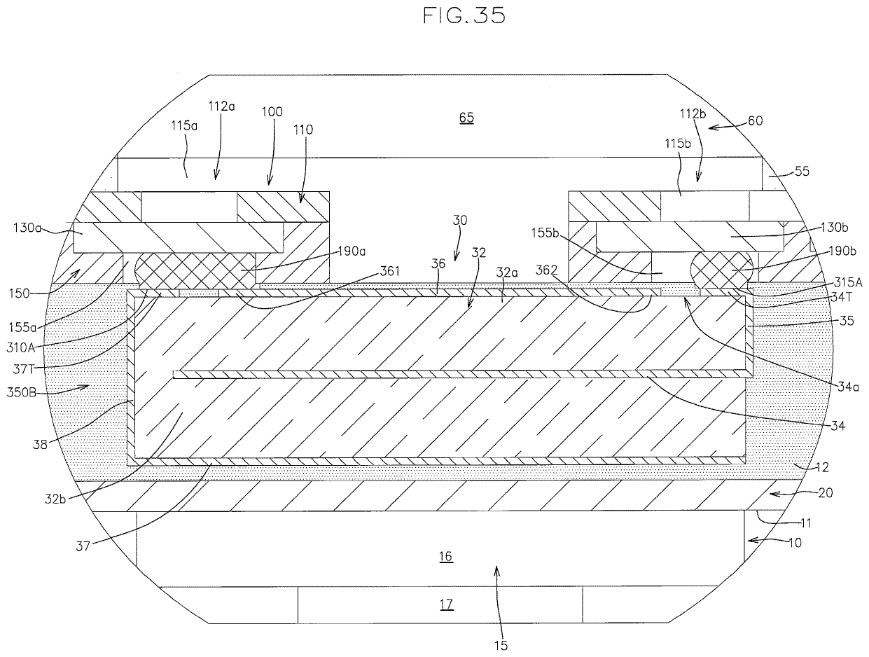

FIG. 35 illustrates an enlarged cross-sectional view of a part of a modified example including the insulating resin material 350B made of a single material.

Hereinafter, a manufacturing method of the ultrasonic transducer 2 is described.

The manufacturing method includes
a rigid substrate forming step of preparing a rigid plate member having the same thickness as the rigid substrate 10, and forming the plurality of opening portions 15 in the rigid plate member by etching or the like to obtain the rigid substrate 10; and
a flexible resin film fixing step of fixing the flexible resin film 20 to an upper surface of the rigid substrate 10 by an adhesive or thermocompression bonding in such a way as to cover the plurality of opening portions 15.

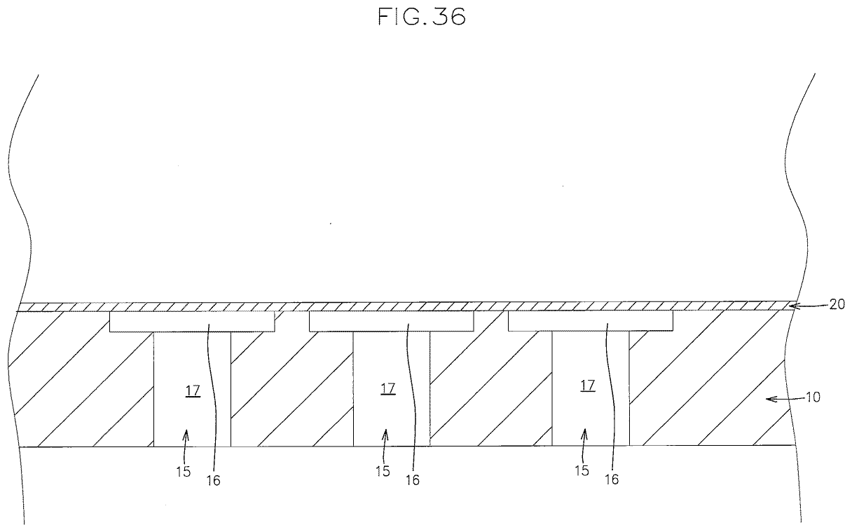

FIG. 36 illustrate a vertical sectional view of a preassembly after the flexible resin film fixing step.

In the present embodiment, the manufacturing method includes a lower sealing plate fixing step of preparing the lower sealing plate 40 having substantially the same thickness as the piezoelectric element 30 and including the central opening 42 of a size that integrally surrounds the plurality of opening portions 15 in the rigid substrate 10, and fixing the lower sealing plate 40 to the upper surface of the flexible resin film 20 by an adhesive in such a way that the central opening 42 integrally surrounds the plurality of opening portions 15 in a plan view.

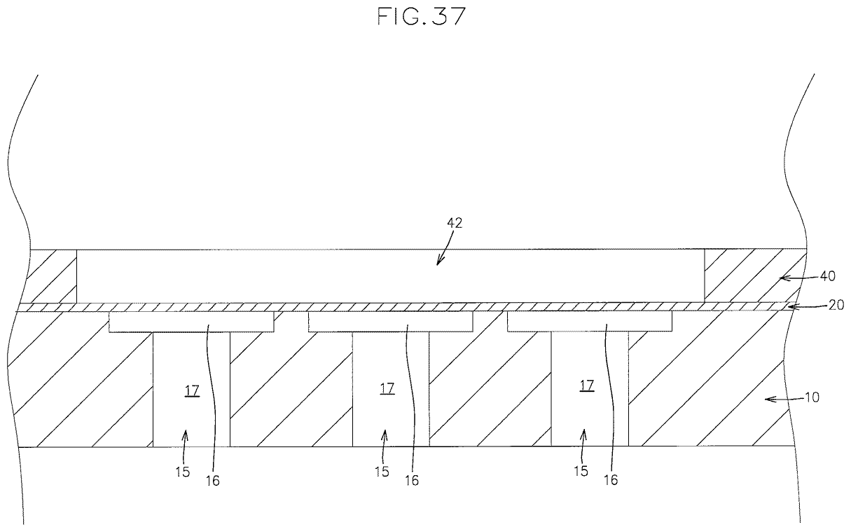

FIG. 37 illustrate a vertical sectional view of the preassembly after the lower sealing plate fixing step.

The manufacturing method further includes a piezoelectric element fixing step of fixing the plurality of piezoelectric elements 30 to the upper surface of the flexible resin film 20 by the first insulating resin material 360 in such a way as to overlap the plurality of opening portions 15 in a plan view, respectively.

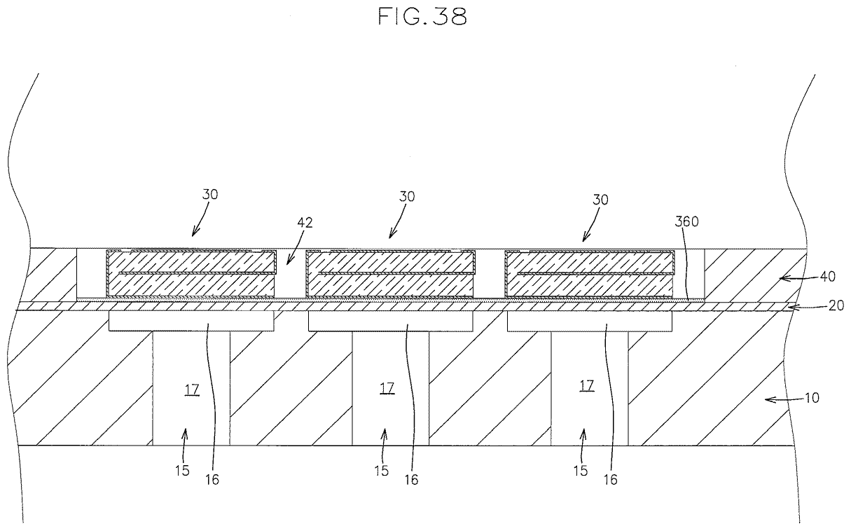

FIG. 38 illustrate a vertical sectional view of the preassembly after the piezoelectric element fixing step.

The order of the lower sealing plate fixing step and the piezoelectric element fixing step can be reversed.

That is, it is possible to perform the piezoelectric element fixing step in advance, and then perform the lower sealing plate fixing step.

The manufacturing method further includes an insulating resin material setting step of setting the second insulating resin material 370 in such a way as to cover the side surfaces of the plurality of piezoelectric elements 30 within the central opening 42, and also cover the upper surfaces of the plurality of piezoelectric elements 30 to form an insulating cover member 300E.

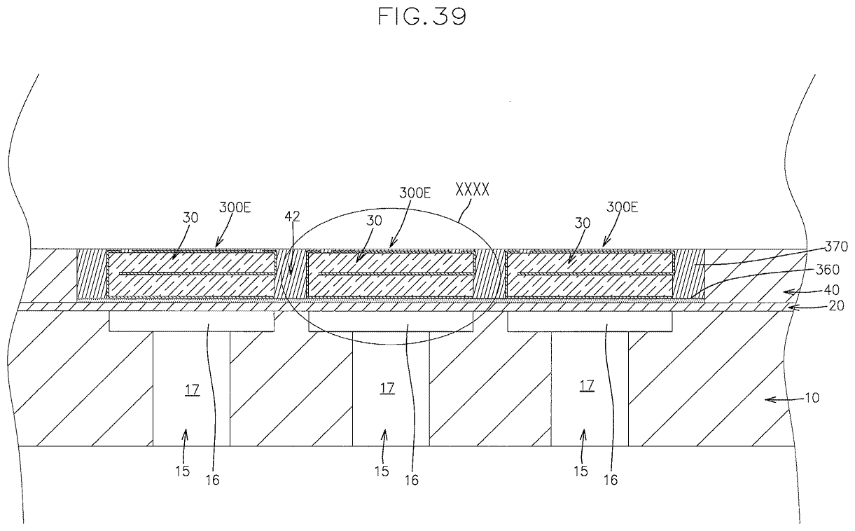

FIG. 39 illustrate a vertical sectional view of the preassembly after the insulating resin material setting step.

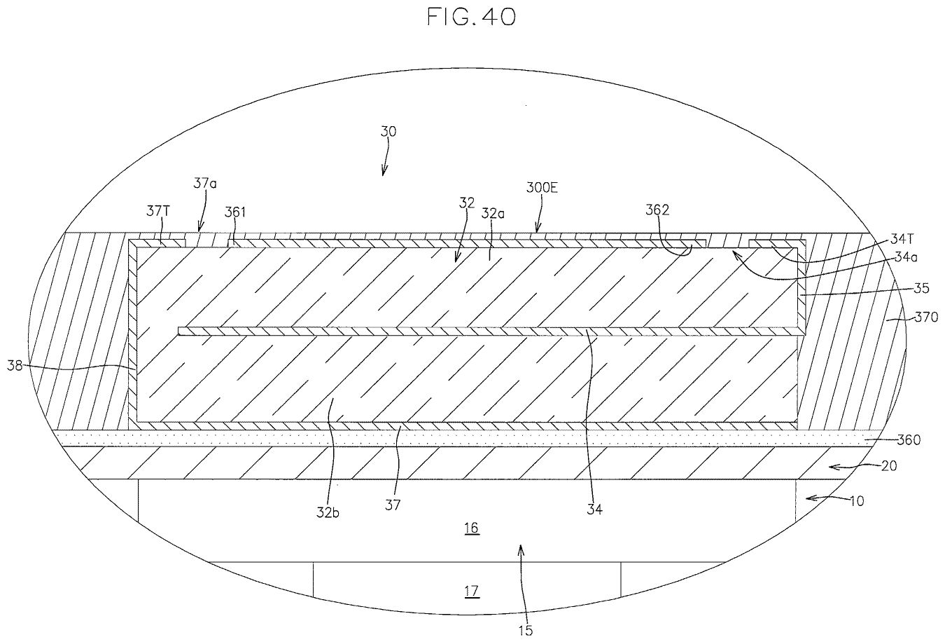

FIG. 40 illustrated an enlarged view of a portion XXXX in FIG. 39.

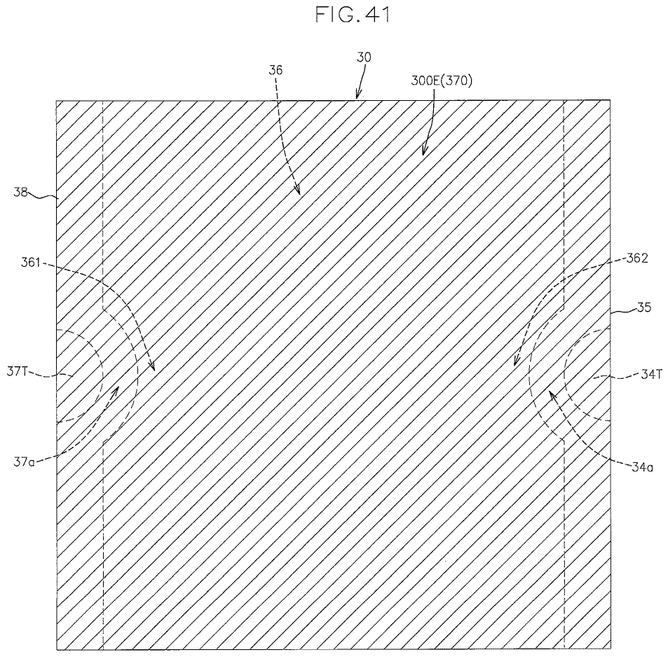

Further, FIG. 41 illustrates a plan view of the piezoelectric element 30 after the insulating resin material setting step.

The second insulating resin material 370 is preferably flexible resin material such as silicone.

The insulating resin material setting step is configured to apply a thermosetting insulating resin material such as silicone in such a way as to cover the upper surfaces and the side surfaces of the plurality of piezoelectric elements 30, and then cure the resin material by heating at the temperature of, for example, 100-150 °C for several tens of minutes.

The manufacturing method further includes an electrode exposing step of forming the external electrode opening 310A that integrally exposes at least a part of the lower electrode terminal 37T and at least a part of the upper electrode 36 and the internal electrode opening 315A that exposes at least a part of the internal electrode terminal 34T without exposing the internal-electrode-terminal facing area 362.

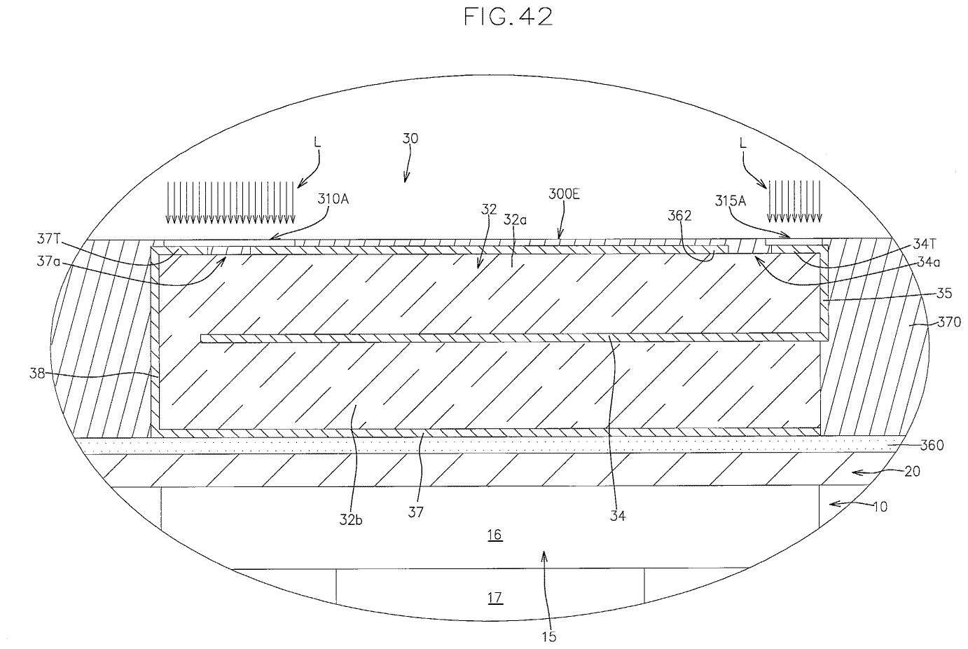

FIG. 42 illustrate an enlarged vertical sectional view of a part of the preassembly after the electrode exposing step.

Further, FIG. 43 illustrates a plan view of the piezoelectric element 30 after the electrode exposing step.

As illustrated in FIG. 42, in the present embodiment, the electrode exposing step is configured to emit laser beam L onto portions of the insulating cover member 300E where the external electrode opening 310A and the internal electrode opening 315A should be formed so as to remove the portions from the insulating cover member 300E to form the external electrode opening 310A and the internal electrode opening 315A.

Alternatively, the external electrode opening 310A and the internal electrode opening 315A can be formed by ion beam, electron beam or ion milling.

The manufacturing method further includes a conductive bonding material setting step of setting the first conductive bonding material 190a in such a way as to integrally cover at least parts of the lower electrode terminal 37T and the upper electrode 36 that are exposed through the external electrode opening 310A, and setting the second conductive bonding material 190b at an area of the internal electrode terminal 34T that is exposed through the internal electrode opening 315A.

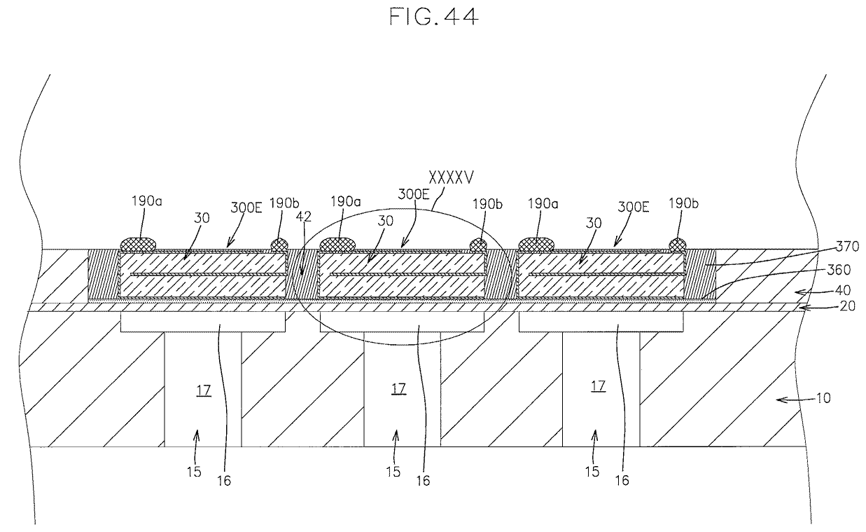

FIG. 44 illustrate a vertical sectional view of the preassembly after the conductive bonding material setting step.

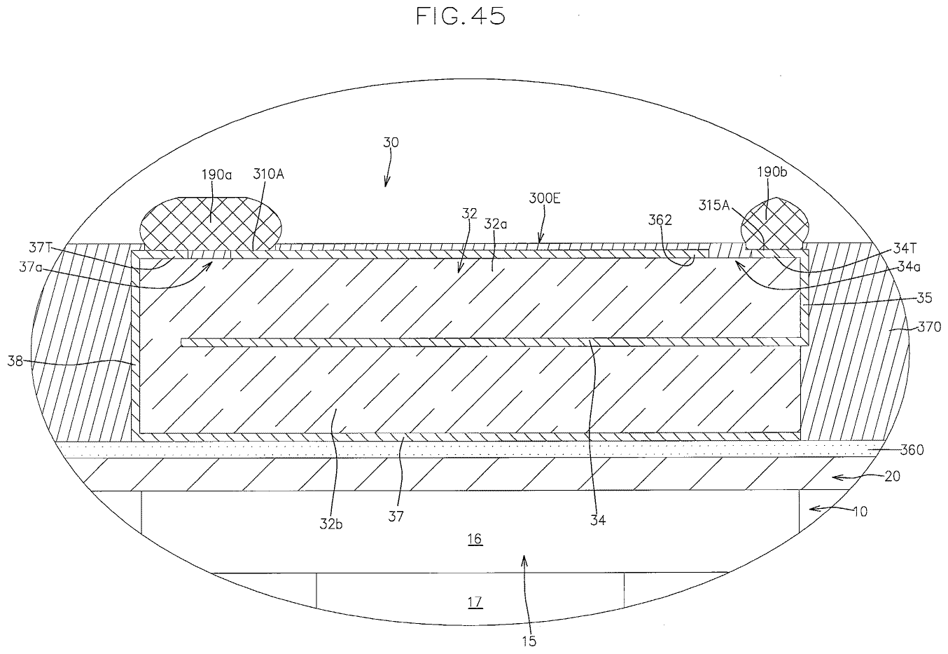

FIG. 45 illustrated an enlarged view of a portion XXXXV in FIG. 44.

The manufacturing method further includes a wiring structure setting step of setting the wiring structure 100 in such a manner that a part of the first wiring 130a comes into contact with the first conductive bonding material 190a and a part of the second wiring 130b comes into contact with the second conductive bonding material 190b.

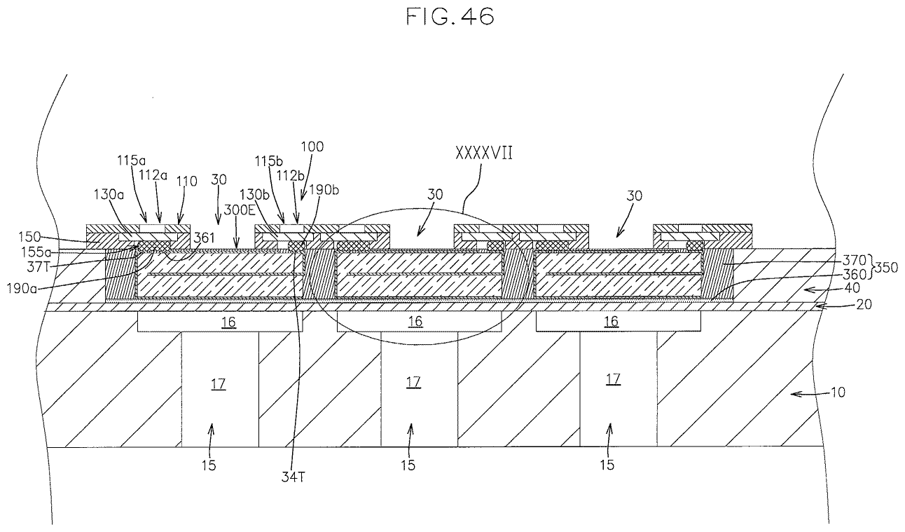

FIG. 46 illustrate a vertical sectional view of the preassembly after the wiring structure setting step.

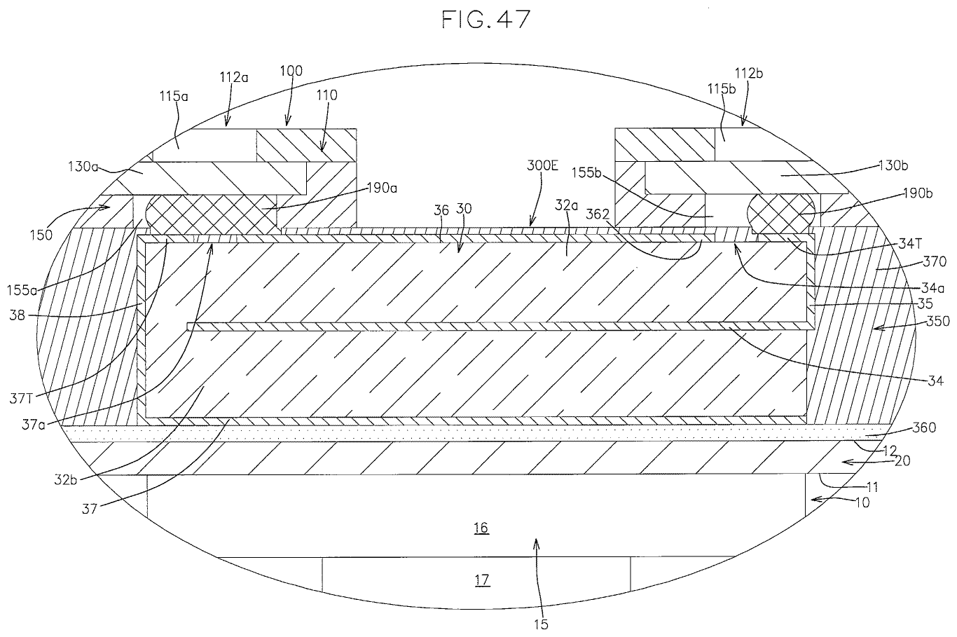

FIG. 47 illustrated an enlarged view of a portion XXXXVII in FIG. 46.

In the present embodiment, the wiring structure setting step is configured so as to fix the wiring structure 100 to the lower sealing plate 40 by an insulating adhesive in such a manner that the portion of the first wiring 130a extending across the external-electrode connection opening 155a comes in contact with the first conductive bonding material 190a, and the portion of the second wiring 130b extending across the internal-electrode connection opening 155b comes in contact with the second conductive bonding material 190b.

The insulating adhesive that fixes the wiring structure 100 to the lower sealing plate 40 may be, for example, a thermosetting insulating adhesive.

The first and second conductive bonding materials 190a and 190b may be, for example, a thermosetting conductive adhesive or cream solder, and be applied at predetermined areas by means of a dispenser, a screen printing device or a transfer device or the like.

The wiring structure setting step is configured to include a heating process that cures the thermosetting insulating adhesive and the first and second conductive bonding materials 190a, 190b while arranging the wiring structure 100 at the predetermined position.

A heating temperature of the heating process may be approximate 120 °C to 150 °C in a case where the first and second conductive bonding materials 190a, 190b each are thermosetting conductive adhesives, and be approximate 230 °C to 260 °C in a case where the first and second conductive bonding materials 190a, 190b each are cream solders. The cream solder is heated to be melt and cooled down from the melted condition to be cured.

The manufacturing method further includes an upper sealing plate installation step of installing the upper sealing plate 60 after the wiring structure setting step.

The upper sealing plate installation step includes a process of applying a thermosetting flexible resin such as a silicone resin to an upper surface of the wiring structure 100, a process of arranging the upper sealing plate 60 on the flexible resin, and a process of curing the flexible resin by heating at, for example, about 100 °C to 150 °C for several tens of minutes.

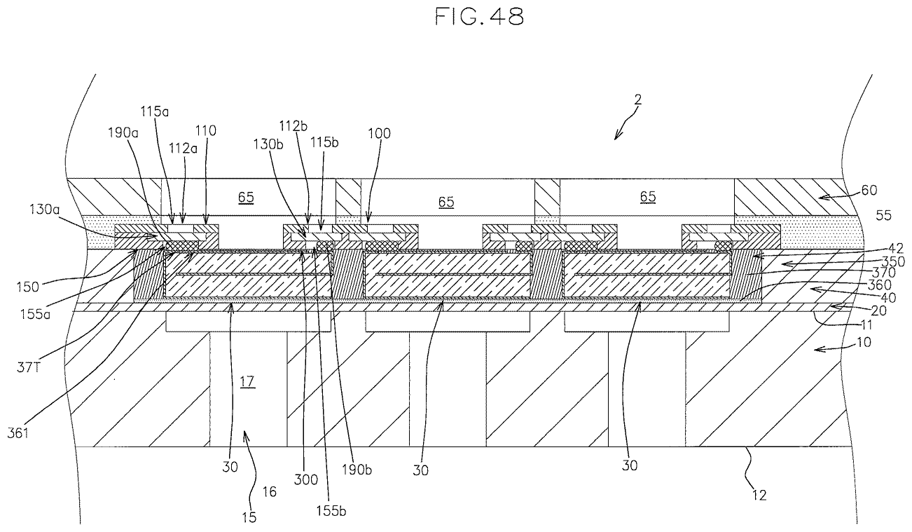

FIG. 48 illustrate a vertical sectional view of the preassembly after the upper sealing plate installation step.

The manufacturing method further includes a sound absorbing member installation step and a reinforcing plate installation step (see FIG. 2) after the upper sealing plate installation step.

The sound absorbing member installation step includes a process of applying a thermosetting insulating adhesive to an upper surface of the upper sealing plate 60, a process of disposing the sound absorbing member 70 such as a silicone resin or another foamable resin on the thermosetting insulating adhesive, and a process of curing the thermosetting insulating adhesive by heating at, for example, about 120 °C to 150 °C for several tens of minutes.

The reinforcing plate installation step includes a process of applying a thermosetting insulating adhesive to an upper surface of the sound absorbing member 70, a process of disposing the reinforcing plate 75 on the thermosetting insulating adhesive, and a process of curing the thermosetting insulating adhesive by heating at, for example, about 120 °C to 150 °C for several tens of minutes.

In the manufacturing method, the insulating resin material (the first insulating resin material 360) that fixes the piezoelectric element 30 to the flexible resin film 20, and the insulating resin material (the second insulating resin material 370) that covers the upper surface of the piezoelectric element 30 to form the insulating cover member 300E are different to each other. However, these resin materials can be made of a single material.

A manufacturing method of the modified example is configured to perform a lower sealing plate setting step, an insulating resin material filling step and the piezoelectric element fixing step in this order after the flexible resin film fixing step.

The lower sealing plate setting step is configured to prepare a lower sealing plate 40B having a thickness larger than the piezoelectric element 30 and including the central opening 42 of a size that integrally surrounds the plurality of opening portions 15 in a plan view, and fix the lower sealing plate 40B to the upper surface of the flexible resin 20 in such a way that the central opening 42 integrally surrounds the plurality of opening portions 15.

The insulating resin material filling step is configured to fill a space in the central opening 42 with an insulating resin material 380.

The insulating resin material 380 may be, for example, a thermosetting insulating resin material.

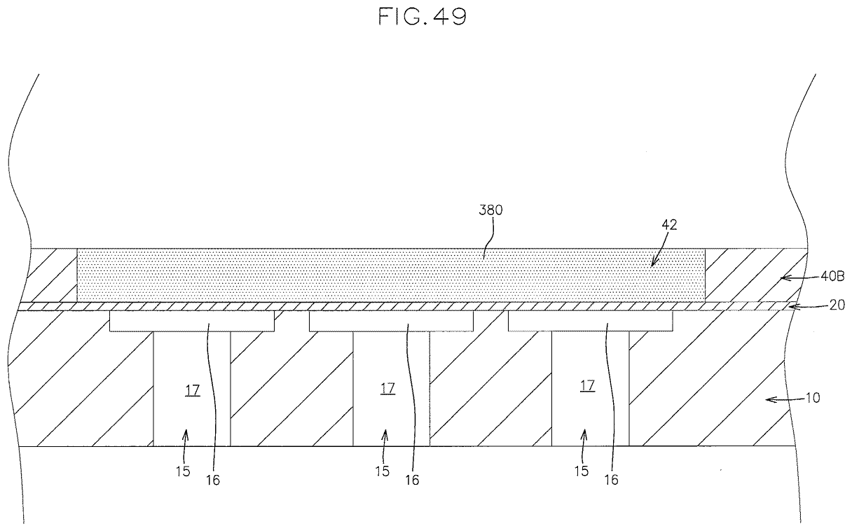

FIG. 49 illustrate a vertical sectional view of the preassembly after the insulating resin material filling step.

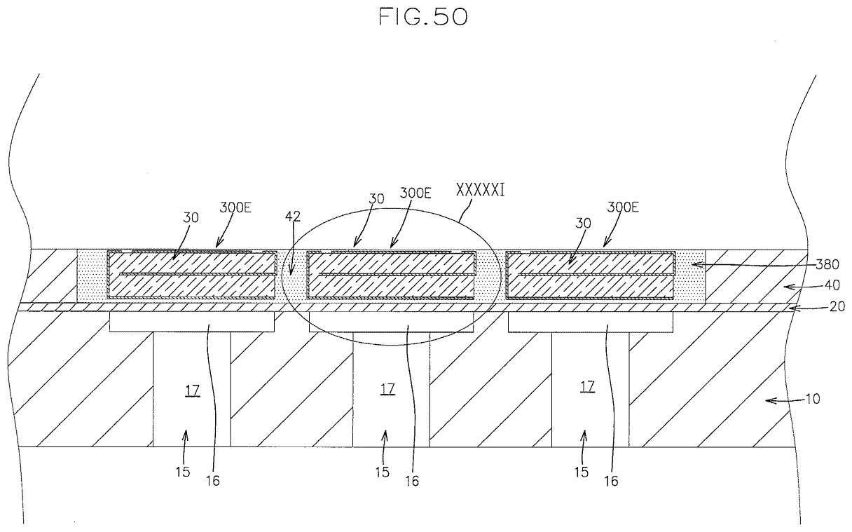

FIG. 50 illustrate a vertical sectional view of the preassembly after the piezoelectric element fixing step.

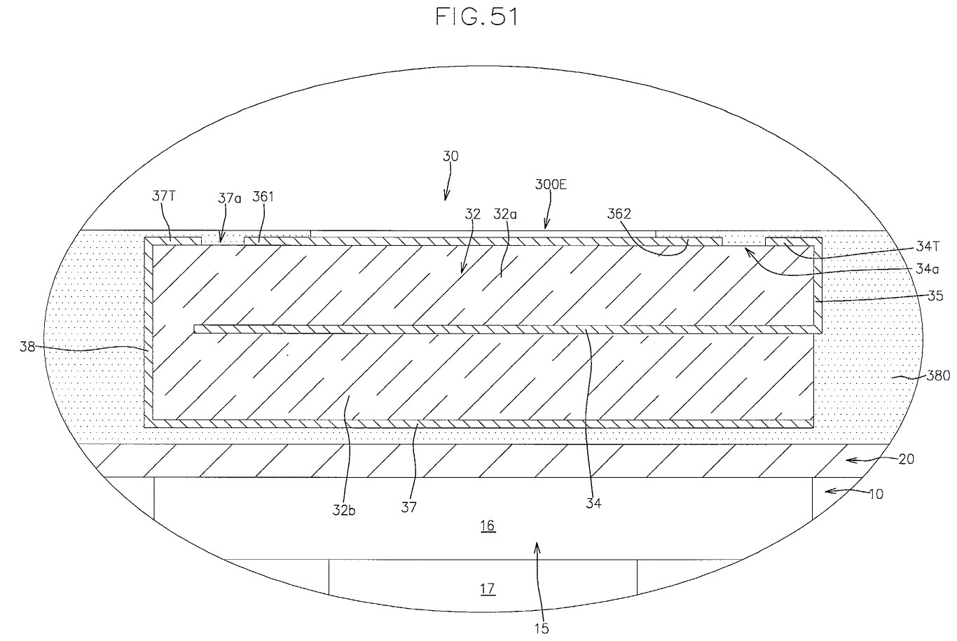

FIG. 51 illustrated an enlarged view of a portion XXXXXI in FIG. 50.

As illustrated in FIGS. 50 and 51, the piezoelectric element fixing step is configured to fix the plurality of piezoelectric elements 30 to the flexible resin film 20 while forming the insulating cover member 300E on the upper surface of each of the plurality of piezoelectric elements 30 by arranging the plurality of piezoelectric elements 30 on the upper surface of the flexible resin film 20 within the insulating resin material 380 before the curing so that the plurality of piezoelectric elements 30 overlap the plurality of opening portions 15 in a plan view, respectively, in a state that a part of the insulating resin material 380 covers the upper surfaces of the plurality of piezoelectric elements 30, and then curing the insulating resin material 380.

In a preferable configuration, as shown in FIG. 51, an amount of the insulating resin material 380 in the piezoelectric element fixing step is adjusted in such a manner that, when the piezoelectric element 30 is mounted on the upper surface of the flexible resin film 20, the insulating resin material 380 overlaps a peripheral region of the upper surface of the piezoelectric element 30 that includes at least a part of the internal electrode terminal 34T, the internal-electrode-terminal facing area 362 of the upper electrode 36 facing the internal electrode terminal 34T via or through the internal-electrode-side gap 34a and the area of the internal-electrode-side gap 34a that is sandwiched by the internal electrode terminal 34T and the internal-electrode-terminal facing area 362, while the insulating resin material 380 does not overlap a central region of the upper surface of the piezoelectric element 30.

The preferable configuration makes it possible to effectively prevent or reduce the insulating resin material 380 from attaching to a picking nozzle for mounting the piezoelectric element 30, thereby mounting the piezoelectric element 30 efficiently and accurately.

The manufacturing method of the modified example performs the same steps as the manufacturing method of the present embodiment after the piezoelectric element fixing step

In the first and second embodiments, as shown in FIG. 8A or the like, the lower electrode terminal 37T and the internal electrode terminal 34T are arranged at center portions of one side and another side forming an outer shape in a plane view, respectively. However, as a matter of course, the present invention is not limited to the configuration.

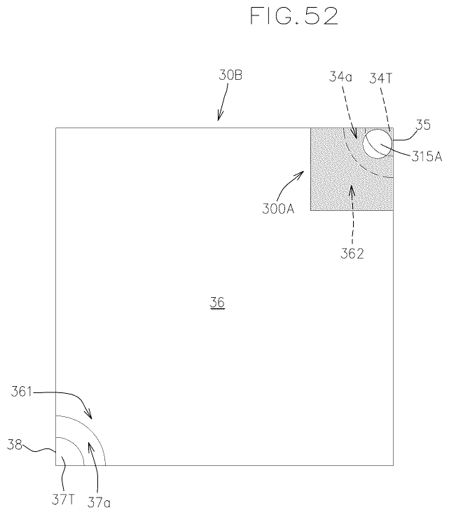

FIG. 52 illustrate a plan view of a piezoelectric element 30B with the insulating cover member 300A according to another embodiment of the present invention.

In the piezoelectric element 30B, the lower electrode terminal 37T and the internal electrode terminal 34T are arranged at corner portions of the rectangular shape in a plan view.

Furthermore, although the lower sealing plate 40 is used in the first and second embodiments, a lower sealing plate 40B may be used in place of the lower sealing plate 40

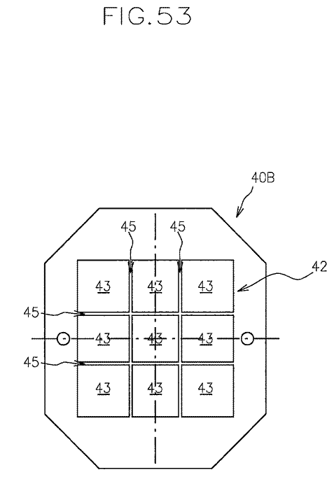

FIG. 53 illustrate a plan view of the lower sealing plate 40B.

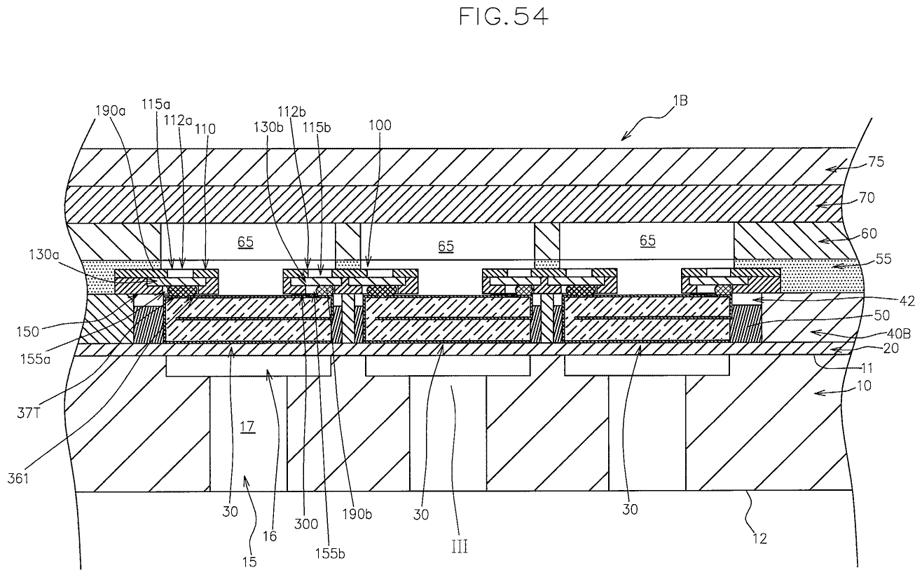

Furthermore, FIG. 54 illustrates a partial vertical sectional view of an ultrasonic transducer 1B in accordance to a modified example of the first embodiment to which the lower sealing plate 40B is applied in place of the lower sealing plate 40.

As shown in FIGS. 53 and 54, the lower sealing plate 40B includes a partition wall that divides the central opening 42 into a plurality of openings 43 having a size that surrounds the corresponding piezoelectric element 30.

### DESCRIPTION OF THE REFERENCE NUMERALS

1, 1B, 2 ultrasonic transducer
10 rigid substrate
15 opening portion
20 flexible resin film
30, 30B piezoelectric element
32 piezoelectric element main body
34 internal electrode
34a internal-electrode-side gap
34T internal electrode terminal
35 internal electrode connector
36 upper electrode (external electrode)
37 lower electrode (external electrode)
37a lower-electrode-side gap
37T lower electrode terminal
38 lower electrode connector
40, 40B lower sealing plate
42 central opening
45 partition wall
100 wiring structure
110 insulating base layer
111 base-side piezoelectric element overlapping portion
112a external-electrode tab area
112b internal-electrode tab area
115a first access opening
115b second access opening
116 base-side tip end portion
130a, 130b first wiring, second wiring
150 insulating cover layer
151 cover-side piezoelectric element overlapping portion
152a external-electrode tab area
152b internal-electrode tab area
155a external-electrode connection opening
155b internal-electrode connection opening
156 cover-side tip portion
190a first conductive bonding material
190b second conductive bonding material
300A-300D insulating cover member
310A, 310B external electrode opening
315A, 315B internal electrode opening
350, 350B insulating resin material
360 first insulating resin material
361 lower-electrode-terminal facing area
362 internal-electrode-terminal facing area
370 second insulating resin material

1. A laminated piezoelectric element comprising:
a piezoelectric element main body made of a piezoelectric material;
upper and lower electrodes provided on upper and lower surfaces of the piezoelectric element main body, respectively, the upper and lower electrodes forming an external electrode;
an internal electrode dividing the piezoelectric element main body into upper and lower sides in a thickness direction;
a lower electrode connector having a base end side electrically connected to the lower electrode and a tip end side forming a lower electrode terminal that is arranged on the upper surface of the piezoelectric element main body in such a manner that there is a lower-electrode-side gap between the tip end side of the lower electrode terminal and the upper electrode;
an internal electrode connector having a base end side electrically connected to the internal electrode and a tip end side forming an internal electrode terminal that is arranged on the upper surface of the piezoelectric element main body in such a manner that there is an internal-electrode-side gap between the tip end side of the internal electrode terminal and the upper electrode;
an insulating cover member integrally covering at least a part of the internal electrode terminal, an internal-electrode-terminal facing area of the upper electrode that faces the internal electrode terminal via or through the internal-electrode-side gap, and an area of the internal-electrode-side gap that is sandwiched by the internal electrode terminal and the internal-electrode-terminal facing area; and
an internal electrode opening provided at the insulating cover member so as to expose at least a part of the internal electrode terminal without exposing the internal-electrode-terminal facing area.

2. The laminated piezoelectric element according to claim 1, wherein the internal electrode opening is configured to expose an area of the internal-electrode-side gap that is adjacent to the exposed part of the internal electrode terminal.

3. The laminated piezoelectric element according to claim 1, wherein the internal electrode opening is configured not to expose the internal-electrode-side gap.

4. The laminated piezoelectric element according to any claim 1,
wherein the insulating cover member is configured to integrally cover at least a part of the lower electrode terminal, a lower-electrode-terminal facing area of the upper electrode facing the lower electrode terminal via or through the lower-electrode-side gap, and an area of the lower-electrode-side gap that is sandwiched by the lower electrode terminal and the lower-electrode-terminal facing area, and
wherein the insulating cover member is provided with, in addition to the internal electrode opening, an external electrode opening that integrally exposes at least a part of the lower electrode terminal and at least a part of the upper electrode.

5. The laminated piezoelectric element according to claim 4, wherein the insulating cover member is configured to cover a whole of the upper surface of the piezoelectric element main body in a plan view.

6. The laminated piezoelectric element according to claim 4, wherein the insulating cover member is configured to cover a part of the upper surface of the piezoelectric element main body in a plan view.

7. A manufacturing method of an ultrasonic transducer including a rigid substrate provided with a plurality of opening portions penetrating between an upper surface and a lower surface, a flexible resin film fixed to the upper surface of the substrate in such a way as to cover the plurality of opening portions, the same number of piezoelectric elements as the plurality of opening portions, the piezoelectric element being fixed to the upper surface of the flexible resin film in such a way that a middle portion thereof overlaps, in a plan view, the corresponding opening portion and a peripheral portion thereof overlaps, in a plan view, the upper surface of the rigid substrate, and a wiring structure including first and second wirings that are electrically connected to external and internal electrodes of the piezoelectric element, respectively, wherein the piezoelectric element includes a piezoelectric element main body made of a piezoelectric material, upper and lower electrodes provided on upper and lower surfaces of the piezoelectric element main body, respectively, the upper and lower electrodes forming the external electrode, the internal electrode dividing the piezoelectric element main body into upper and lower sides in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode, the manufacturing method comprising:
a rigid substrate forming step of preparing a rigid plate member having the same thickness as the rigid substrate and forming the plurality of opening portions in the rigid plate member to obtain the rigid substrate;
a flexible resin film fixing step of fixing the flexible resin film to the upper surface of the rigid substrate so as to cover the plurality of opening portions;
a piezoelectric element fixing step of fixing the plurality of piezoelectric elements to the upper surface of the flexible resin film by an insulating adhesive in such a way as to overlap, in a plan view, the plurality of opening portions, respectively;
an insulating cover member setting step of setting an insulating cover member on the upper surface of the piezoelectric element in such a manner as to integrally cover at least a part of the internal electrode terminal, an internal-electrode-terminal facing area of the upper electrode facing the internal electrode terminal via or through the internal-electrode-side gap and an area of the internal-electrode-side gap that is sandwiched by the internal electrode terminal and the internal-electrode-terminal facing area;
an electrode exposing step of forming, in the insulating cover member, an internal electrode opening that exposes at least a part of the internal electrode terminal without exposing the internal-electrode-terminal facing area;
a conductive bonding material setting step of setting a first conductive bonding material in such a way as to integrally cover at least a part of the lower electrode terminal and at least a part of a lower-electrode-terminal facing area of the upper electrode facing the lower electrode terminal via or through the lower-electrode-side gap, and setting a second conductive bonding material at an area of the internal electrode terminal that is exposed through the internal electrode opening; and
a wiring structure setting step of setting the wiring structure in such a manner that a part of the first wiring comes into contact with the first conductive bonding material and a part of the second wiring comes into contact with the second conductive bonding material.

8. The manufacturing method of the ultrasonic transducer according to claim 7, wherein the electrode exposing step is configured to form the internal electrode opening by emitting laser beam onto a portion of the insulating cover member where the internal electrode opening should be formed.

9. The manufacturing method of the ultrasonic transducer according to claim 7, wherein the insulating cover member is configured not to cover at least a part of the lower electrode terminal, the lower-electrode-terminal facing area of the upper electrode facing the lower electrode terminal via or through the lower-electrode-side gap, and an area of the lower-electrode-side gap that is sandwiched by the lower electrode terminal and the lower-electrode-terminal facing area.

10. The manufacturing method of the ultrasonic transducer according to claim 7,
wherein the insulating cover member is configured to integrally cover at least a part of the lower electrode terminal, the lower-electrode-terminal facing area of the upper electrode facing the lower electrode terminal via or through the lower-electrode-side gap, and an area of the lower-electrode-side gap that is sandwiched by the lower electrode terminal and the lower-electrode-terminal facing area,
wherein the electrode exposing step is configured to form, in addition to the internal electrode opening, an external electrode opening that integrally exposes at least a part of the lower electrode terminal and at least a part of the upper electrode, and
wherein the conductive bonding material setting step is configured to set the first conductive bonding material within the external electrode opening.

11. The manufacturing method of the ultrasonic transducer according to claim 7, further comprising:
a lower sealing plate fixing step of preparing a lower sealing plate that has the substantially same thickness as the piezoelectric element and includes a central opening of a size integrally surrounding the plurality of opening portions in the rigid substrate, and fixing the lower sealing plate to the upper surface of the flexible resin film in such a way that the central opening integrally surrounds the plurality of opening portions in a plan view,
wherein the lower sealing plate fixing step is performed at an arbitrary timing after the flexible resin film fixing step and before the wiring structure setting step, and
wherein the wiring structure setting step is configured so as to mount the wiring structure onto the lower sealing plate.

12. The manufacturing method of the ultrasonic transducer according to claim 11, further comprising an insulating resin material filling step that is performed after the lower sealing plate fixing step and the piezoelectric element fixing step and before the wiring structure setting step,
wherein the insulating resin material filling step is configured to fill with an insulating resin material a side space of each of the plurality of piezoelectric elements within a space surrounded by the central opening of the lower sealing plate.

13. The manufacturing method of the ultrasonic transducer according to claim 11, wherein the lower sealing plate includes a partition wall that divides the central opening into a plurality of openings having a size that surrounds the corresponding piezoelectric element.

14. An ultrasonic transducer comprising:
a rigid substrate provided with a plurality of opening portions penetrating between an upper surface and a lower surface;
a flexible resin film fixed to the upper surface of the substrate in such a way as to cover the plurality of opening portions;
a lower sealing plate having a central opening of a size that integrally surrounds the plurality of opening portions, and fixed to the upper surface of the flexible resin film in such a way that the central opening integrally surrounds the plurality of opening portions in a plan view;
a plurality of piezoelectric elements arranged onto the upper surface of the flexible resin film within the central opening so as to overlap, in a plan view, the plurality of opening portions, respectively;
an insulating resin material fixing the plurality of piezoelectric elements at respective arrangement positions; and
a wiring structure including first and second wirings and fixed to an upper surface of the lower sealing plate,
wherein the piezoelectric element includes a piezoelectric element main body made of a piezoelectric material, upper and lower electrodes provided on upper and lower surfaces of the piezoelectric element main body, respectively, the upper and lower electrodes forming an external electrode, an internal electrode dividing the piezoelectric element main body into an upper side and a lower side in a thickness direction, a lower electrode connector having a base end side electrically connected to the lower electrode and a tip end side forming a lower electrode terminal that is arranged on the upper surface of the piezoelectric element main body in such a manner that there is a lower-electrode-side gap between the lower electrode terminal and the upper electrode, and an internal electrode connector having a base end side electrically connected to the internal electrode and a tip end side forming an internal electrode terminal that is arranged on the upper surface of the piezoelectric element main body in such a manner that there is an internal-electrode-side gap between the internal electrode terminal and the upper electrode,
wherein the insulating resin material is provided in such a way as to be interposed between lower surfaces of the plurality of piezoelectric elements and the flexible resin film, and also cover side surfaces and upper surfaces of the plurality of piezoelectric elements,
wherein a portion of the insulating resin material that covers an upper surface of the piezoelectric element to form an insulating cover member is provided with an external electrode opening that integrally exposes at least a part of the lower electrode terminal and at least a part of the upper electrode, and an internal electrode opening that exposes at least a part of the internal electrode terminal without exposing the internal-electrode-terminal facing area,
wherein the first wiring is electrically connected via a first conductive bonding material to the lower electrode terminal and the upper electrode that are exposed by the external electrode opening, and
wherein the second wiring is electrically connected via a second conductive bonding material to the internal electrode terminal that is exposed by the internal electrode opening.

15. The piezoelectric element assembly ultrasonic transducer according to claim 14, wherein the insulating resin material includes a first insulating resin material that fixes the lower surfaces of plurality of the piezoelectric element to the flexible resin film, and a second insulating resin material that covers the side surfaces and the upper surfaces of the plurality of the piezoelectric element.

16. The ultrasonic transducer according to claim 14, wherein the insulating resin material is made of a single material.

17The ultrasonic transducer according to claim 14, wherein the lower sealing plate includes a partition wall that divides the central opening into a plurality of openings having a size that surrounds the corresponding piezoelectric element.

18. The ultrasonic transducer according to claim 14,
wherein the wiring structure includes an insulating base layer supporting the first and second wirings, and an insulating cover layer covering at least parts of the first and second wirings from a side opposite to the base layer,
wherein the base layer and the cover layer each include a plurality of piezoelectric element overlapping portions that partially overlap, in a plan view, the plurality of piezoelectric elements, respectively, and a tip end portion that integrally holds the plurality of piezoelectric element overlapping portions,
wherein the piezoelectric element overlapping portion of a piezoelectric-element-side insulating layer out of the base layer and the cover layer, which is located on a side facing the piezoelectric element, includes an external-electrode tab area that overlaps, in a plan view, an area integrally surrounding at least a part of the lower electrode terminal and at least a part of the lower-electrode-terminal facing area and includes an external-electrode connection opening, and an internal-electrode tab area that overlaps, in a plan view, at least a part of the internal electrode terminal and includes an internal-electrode connection opening,
wherein a part of the first wiring extends across or straddles the external-electrode connection opening, and a part of the second wiring extends across or straddles the internal-electrode connection opening,
wherein the wiring structure is fixed to the upper surface of the lower sealing plate in a state that the external-electrode connection opening overlaps, in a plan view, the area that integrally includes at least a part of the lower electrode terminal and at least a part of the lower-electrode facing area, and the internal-electrode connection opening overlaps, in a plan view, at least a part of the internal electrode terminal,
wherein the part of the first wiring extending across the external-electrode connection opening is bonded to the first conductive bonding material, and
wherein the part of the second wiring extending across the internal-electrode connection opening is bonded to the second conductive bonding material.

19. The ultrasonic transducer according to claim 18, wherein the piezoelectric element overlapping portion of the insulating layer out of the base layer and the cover layer, which is located on a side away from the piezoelectric element, includes an external-electrode tab area that overlaps, in a plan view, an area integrally surrounding at least a part of the lower electrode terminal and at least a part of the lower-electrode-terminal facing area and includes a first access opening, and an internal-electrode tab area that overlaps, in a plan view, at least a part of the internal electrode terminal and includes a second access opening.

20-24. (canceled)
